(19) United States
(12) Patent Application Publication
(10) Pub. No.: US 2018/0025588 A1
(43) Pub. Date: Jan. 25, 2018

(54) Gaming Machine and Method

(71) Applicant: Ainsworth Game Technology Limited, Newington (AU)

(72) Inventors: Jun Ma, Sydney (AU); Waruna Manchanayake, Sydney (AU)

(21) Appl. No.: 15/218,975

(22) Filed: Jul. 25, 2016

(51) Int. Cl. G07F 17/34; G07F 17/32

(52) U.S. Cl. CPC G07F 17/34; G07F 17/3211; G07F 17/3209; G07F 17/3246; G07F 17/3248; G07F 17/3225

(57) ABSTRACT

The invention in one aspect provides a gaming machine comprising a display for displaying a game comprising game symbols arranged into an array of game positions. A game controller provides a symbol meter for at least one game symbol shown in the array. The symbol meter has a value. Where at least one winning combination appears on the array that has the at least one game symbol, the game controller awards a prize based in part on the value of the symbol meter. In another aspect, the symbol moves to the win meter to increase the amount of the win meter by the value of the symbol meter. A method is also provided.

### BACKGROUND

The present invention relates to a gaming machine. The invention has been developed primarily for use as an electronic gaming machine and will be described hereinafter by reference to this application. However, it will be appreciated that the invention may also be implemented for any type of gaming machine, including a mechanical or electro-mechanical gaming machine.

The following discussion of the prior art is intended to present the invention in an appropriate technical context and allow its advantages to be properly appreciated. Unless clearly indicated to the contrary, however, reference to any prior art in this specification should not be construed as an express or implied admission that such art is widely known or forms part of common general knowledge in the field.

Conventional gaming machines typically involve awarding prizes to a player according to predetermined combinations of game symbols that appear on an array of game squares displayed on a screen, typically organised into three rows and five columns (a 5×3 array). Other arrays, such as a 3×3 or 4×3, may be used. Each gaming machine randomly selects the game symbols that appear on the array, each column of the array being a “reel”.

One type of gaming machine comprises a mechanical or electro-mechanical device, where a motor rotates a plurality of annular rings or drums that form reels. Each reel has a reel strip that displays game symbols in preset game symbol positions. A frame covers the rings to provide a window through which only a subset of game symbol positions (and hence game symbols) were visible to the player. Thus, for a game using a 5×3 array, the window would only permit three rows of five rings to be visible to create the game array. An internal game controller within the gaming machine controls operation of the motor and hence rotation of the reels. Thus, by controlling when each reel starts and stops in its respective rotation, the game controller controls the display of the game symbols in the window. Sensors linked to the reels indicate which game symbols are displayed in the window and communicate with the game controller so that the game controller is able to award prizes based on winning combinations of game symbols displayed on the reels in the window. The game controller typically comprises one or more electric circuits for controlling various functions of the gaming machine, such as the above mentioned control of the motor, communicating with the sensors, verifying that the correct amount of a bet has been made via one or more value receiving mechanisms to enable operation of the motors, controlling any visual and/or audio effects associated with operation of the gaming machine and controlling operation of various alarms to alert any tampering with the gaming machine.

Another type of gaming machine, known as an electronic gaming machine or EGM, replaces the mechanical reels and motor with a video display screen on which video images of the reels are displayed. The EGM has an internal electronic game controller, typically a computer, that controls the display of images on the video display screen so that the reels are visibly spun on the screen to simulate a physical reel of a traditional gaming machine. EGMs tend to be more versatile in providing game information, varying the probabilities for a player to win a prize and varying the type of game that is played.

Bonus or “feature” games may also be provided by a gaming machine in addition to a base or main game. Typically feature games use the same set of reels as the main game and are limited to a set of free games operated under a single set of rules. Also, gaming machines can offer one or more bonus prizes to the player during play of the game. The most common type of bonus prize that is awarded by the gaming machine is a jackpot prize, the main example of which is a progressive jackpot prize.

This standard structure to game play and bonus prizes limits the operation of the gaming machine, irrespective of whether it is a mechanical, electro-mechanical or electronic gaming machine. Consequently, it is difficult for game designers to develop new gaming machines and to retain player interest because there is no apparent incentive for the player to continue playing the gaming machine once the player becomes familiar with the feature game, the main game and any bonus prizes.

It is an object of the present invention to overcome or substantially ameliorate one or more of the disadvantages of prior art, or at least to provide a useful alternative.

### SUMMARY

The present invention provides a gaming machine that has improved operation and performance relative to existing prior art gaming machines by providing a more efficient way of awarding prizes to a player of the gaming machine and in a more entertaining manner compared to presently existing gaming machines. The present invention also improves the application of a game controller in playing the game on the gaming machine.

In an aspect, one embodiment of the invention provides a gaming machine comprising:

a display for displaying a game, wherein said game comprises randomly selected game symbols displayed in an array of game positions and where predetermined winning combinations of said randomly selected game symbols in said game award prizes to a player; and

a game controller for controlling the display of said game symbols on said display; and

wherein game controller said provides a symbol meter for at least one game symbol shown in said array, wherein said symbol meter has a value;

in response to at least one winning combination appearing on said array comprising said at least one game symbol, said game controller awards a prize for said at least one winning combination based in part on the value of said symbol meter of said at least one game symbol; and

said symbol meter moves toward a win meter to increase the amount of said win meter by the value of said symbol meter.

Another embodiment of the invention provides a gaming machine comprising:

a display for displaying a game, wherein said game comprises randomly selected game symbols displayed in an array of game positions and where predetermined winning combinations of said randomly selected game symbols in said game award prizes to a player; and

a game controller for controlling the display of said game symbols on said display, wherein said game controller is configured to:
randomly select said game symbols for display in said game positions of said array;
provide a symbol meter for at least one game symbol shown in said array, wherein said symbol meter has a value;
causing said display to display said randomly selected game symbols;
determining whether any of said winning combinations appear on said array;
in response to the display of at least one of said winning combinations comprising said at least one game symbol, awarding a prize for said at least one winning combination based on in part on the value of said symbol meter; and
said symbol meter moves toward a win meter to increase the amount of said win meter by the value of said symbol meter.

A further embodiment of the invention provides a gaming machine comprising:

a display for displaying a game to be played on said gaming machine;

a game controller for controlling operation of the gaming machine, said game controller comprising:
a display controller for controlling the display of game symbols on said display, wherein said display controller is configured to arrange game symbols into an array of game positions on said display;
a game assessor for determining whether one or more predetermined winning combinations of randomly selected game symbols appear in said game positions on said array;
a symbol meter allocator for allocating a symbol meter for at least one game symbol; and
a game symbol selector for selecting the location of said game symbols in said game positions; wherein

said game symbol selector randomly selects said game symbols for displaying said game positions and communicates with said display controller to display said randomly selected game symbols in said game positions on said array;

said symbol meter allocator allocates a symbol meter for at least one of said selected game symbols and a value for each symbol meter;

said game assessor determines whether any of said winning combinations appear on said array;

in response to the display of at least one of said winning combinations comprising said at least one selected game symbol, said game assessor awarding a prize for said at least one winning combination based in part on the on the value of said symbol meter; and

said display controller causing said symbol meter to move towards a win meter to increase the amount of said win meter by the value of said symbol meter.

A further embodiment of the invention provides a gaming machine comprising:

a display for displaying a game, wherein said game comprises randomly selected game symbols displayed in an array of game positions and where predetermined winning combinations of said randomly selected game symbols in said game award prizes to a player;

a game controller for controlling the display of said game symbols on said display; and

a value transfer mechanism for receiving value from said player, wherein said game controller communicates with said value transfer mechanism such that when a threshold amount of value has been received from said value transfer mechanism, said game controller initiates a play of said game;

wherein game controller said provides a symbol meter for at least one game symbol shown in said array, wherein said symbol meter has a value;

in response to at least one winning combination appearing on said array comprising said at least one game symbol, said game controller awards a prize for said at least one winning combination based in part on the value of said symbol meter of said at least one game symbol; and

said symbol meter moves toward a win meter to increase the amount of said win meter by the value of said symbol meter.

Yet another embodiment of the invention provides a method of operating a gaming machine comprising a display and a game controller, the method comprising:

controllably displaying game symbols for playing a game, wherein said game comprises game symbols and predetermined winning combinations of randomly selected game symbols award prizes to a player;

randomly selecting said game symbols;

providing a symbol meter for at least one of said selected game symbols;

providing a value for said symbol meter;

displaying said randomly selected game symbols in an array of game positions;

determining whether any of said winning combinations appear on said array;

in response to the display of at least one of said winning combinations comprising said at least one selected symbol, awarding a prize for said at least one winning combination based in part on the value of said symbol meter;

displaying said symbol meter moving toward a win meter; and

increasing the amount of said win meter by the value of said symbol meter.

A yet further embodiment of the invention provides a method for a gaming machine comprising a display for displaying a game, a game controller for controlling the display of said game symbols for playing said game on said display; and a value transfer mechanism for receiving value from said player to initiate a play of said game, the method comprising:

said value transfer mechanism receiving value from said player;

determining whether said received value meets a threshold amount;

initiating a play of said game if said received value is equal to or greater than said threshold amount;

controllably displaying game symbols for playing said game, wherein said game comprises predetermined winning combinations of randomly selected game symbols award prizes to a player;

randomly selecting said game symbols;

providing a symbol meter for at least one of said selected game symbols;

providing a value for said symbol meter;

displaying said randomly selected game symbols in an array of game positions;

determining whether any of said winning combinations appear on said array;

in response to the display of at least one of said winning combinations comprising said at least one selected symbol, awarding a prize for said at least one winning combination based in part on the value of said symbol meter;

displaying said symbol meter moving toward a win meter; and

increasing the amount of said win meter by the value of said symbol meter.

In another aspect, one embodiment of the invention provides a gaming machine comprising:

a display for displaying a game, wherein said game comprises randomly selected game symbols displayed in an array of game positions and where predetermined winning combinations of said randomly selected game symbols in said game award prizes to a player; and

a game controller for controlling the display of said game symbols on said display;

wherein said game controller provides a symbol meter for at least one said game symbol shown in said array, wherein said symbol meter has a value; and

in response to at least one winning combination comprising said at least one game symbol appearing on said array, said game controller awards a prize for said at least one winning combination based in part on the value of said symbol meter.

Another embodiment of the invention provides a gaming machine comprising:

a display for displaying a game, wherein said game comprises randomly selected game symbols displayed in an array of game positions and where predetermined winning combinations of said randomly selected game symbols in said game award prizes to a player; and

a game controller for controlling the display of said game symbols on said display, wherein said game controller is configured to:
randomly select said game symbols for display in said game positions of said array;
provide a symbol meter for at least one of said selected game symbols, wherein said symbol meters each have a value;
causing said display to display said randomly selected game symbols;
determining whether any of said winning combinations appear on said array; and
in response to at least one winning combination comprising said at least one game symbol appearing on said array, said game controller awards a prize for said at least one winning combination based in part on the value of said symbol meter.

A further embodiment of the invention provides a gaming machine comprising:

a display for displaying a game to be played on said gaming machine;

a game controller for controlling operation of the gaming machine, said game controller comprising:
a display controller for controlling the display of game symbols on said display, wherein said display controller is configured to arrange game symbols into an array of game positions on said display;
a game assessor for determining whether one or more predetermined winning combinations of randomly selected game symbols appear in said game positions on said array;
a symbol meter allocator for allocating a symbol meter for a game symbol; and
a game symbol selector for selecting the location of said game symbols in said game positions; wherein

said game symbol selector randomly selects said game symbols for displaying said game positions and communicates with said display controller to display said randomly selected game symbols in said game positions on said array;

said symbol meter allocator allocates a symbol meter for at least one selected game symbol and a value for said symbol meter;

said game assessor determines whether any of said winning combinations appear on said array; and

in response to at least one winning combination comprising said at least one selected game symbol appearing on said array, said game controller awards a prize for said at least one winning combination based in part on the value of said symbol meter, said game assessor awarding a prize for said at least one winning combination based in part on the value of said symbol meter.

A further embodiment of the invention provides a gaming machine comprising:

a display for displaying a game, wherein said game comprises randomly selected game symbols displayed in an array of game positions and where predetermined winning combinations of said randomly selected game symbols in said game award prizes to a player;

a game controller for controlling the display of said game symbols on said display; and

a value transfer mechanism for receiving value from said player, wherein said game controller communicates with said value transfer mechanism such that when a threshold amount of value has been received from said value transfer mechanism, said game controller initiates a play of said game;

wherein said game controller provides a symbol meter for at least one game symbol shown in said array, wherein said symbol meter has a value; and

in response to at least one winning combination comprising said at least one game symbol appearing on said array, said game controller awards a prize for said at least one winning combination based in part on the value of said symbol meter.

Yet another embodiment of the invention provides a method of operating a gaming machine comprising a display and a game controller, the method comprising:

controllably displaying game symbols for playing a game, wherein said game comprises game symbols and predetermined winning combinations of randomly selected game symbols award prizes to a player;

randomly selecting said game symbols;

providing a symbol meter for at least one of said selected game symbols;

providing a value for said symbol meter;

displaying said randomly selected game symbols in an array of game positions;

determining whether any of said winning combinations appear on said array;

in response to the display of at least one of said winning combinations comprising said at least one selected symbol, awarding a prize for said at least one winning combination based in part on the value of said symbol meter.

A yet further embodiment of the invention provides a method for a gaming machine comprising a display for displaying a game, a game controller for controlling the display of said game symbols for playing said game on said display; and a value transfer mechanism for receiving value from said player to initiate a play of said game, the method comprising:

said value transfer mechanism receiving value from said player;

determining whether said received value meets a threshold amount;

initiating a play of said game if said received value is equal to or greater than said threshold amount;

controllably displaying game symbols for playing said game, wherein said game comprises predetermined winning combinations of randomly selected game symbols award prizes to a player;

randomly selecting said game symbols;

providing a symbol meter for at least one of said selected game symbols;

providing a value for said symbol meter;

displaying said randomly selected game symbols in an array of game positions;

determining whether any of said winning combinations appear on said array; and

in response to the display of at least one of said winning combinations comprising said at least one selected game symbol, awarding a prize for said at least one winning combination based in part on the value of said symbol meter.

A further embodiment of the invention provides a computer system comprising a central processing unit configured for communication with a gaming machine, wherein said computer system is configured to perform the method of any one of the above described embodiments of the invention.

A further embodiment of the invention provides a computer program configured to perform the method of any one of the above described embodiments of the invention.

A further embodiment of the invention provides a non-transitory carrier medium carrying computer executable code that, when executed on a central processing unit configured for communication with a gaming machine, causes the central processing unit to perform the method of any one of the above described embodiments of the invention.

Throughout the specification and unless explicitly stated otherwise, the term “value” means credits, gaming tokens, coins, paper, currency, tickets, vouchers, credit cards, debit cards, smart cards, memory devices capable of storing value and any other object representative of value.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Furthermore, as used herein and unless otherwise specified, the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### BRIEF DESCRIPTION OF THE DRAWINGS

Preferred embodiments of the invention will now be described, by way of example only, with reference to the accompanying drawings in which:

FIG. 1 is a perspective view of a gaming machine according to a first embodiment of the invention;

FIG. 2 is a schematic drawing of a game controller for the gaming machine of FIG. 1;

FIG. 3 is a front view of the display of the gaming machine of FIG. 1 illustrating a base game;

FIG. 4 is a partial simulated screen shot illustrating another game played on the electronic gaming machine of FIG. 1;

FIG. 5 is a partial simulated screen shot illustrating the game of FIG. 4;

FIG. 6 is a partial simulated screen shot illustrating the game of FIG. 4;

FIG. 7 is a partial simulated screen shot illustrating a further game played on the electronic gaming machine of FIG. 1;

FIG. 8 is a partial simulated screen shot illustrating the game of FIG. 7;

FIGS. 9 to 24 are partial simulated screen shots illustrating a sequence in which a prize is awarded for the game of FIG. 7;

FIG. 25 is a schematic drawing illustrating a game according to another embodiment of the invention;

FIG. 26 is a schematic drawing illustrating a game according to a further embodiment of the invention;

FIG. 27 is a perspective view of an electronic gaming machine according to yet another embodiment of the invention;

FIG. 28 is a schematic drawing of a control panel for the electronic gaming machine of FIG. 27; and

FIG. 29 is a block diagram of the electronic components of the electronic gaming machine of FIG. 27.

### DETAILED DESCRIPTION OF VARIOUS EMBODIMENTS

The present invention will now be described with reference to the following examples which should be considered in all respects as illustrative and non-restrictive. In the Figures, corresponding features within the same embodiment or common to different embodiments have been given the same reference numerals.

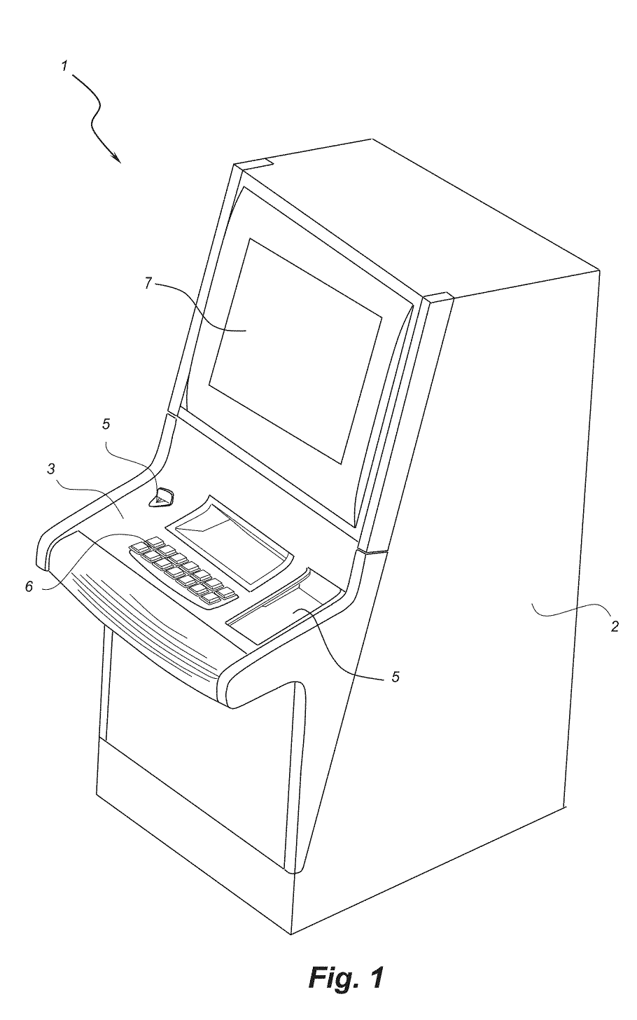

Referring to FIG. 1, a gaming machine 1 according to a first embodiment of the invention includes a cabinet 2, a console 3 and an internal game controller 4. The console 3 has various input devices including vending slots 5 for receiving monetary bets and a plurality of buttons 6 for actuation by a player. It will be appreciated that in other embodiments the vending slots 5 may be replaced with other types of value input/value output devices, such as a coin acceptor, a paper currency acceptor, a ticket reader and/or printer or a card reader and/or writer.

The vending slots 5 can be configured to receive value, such as cash in the form of banknotes and coins, or credits representing a monetary amount from a memory device, such as but not limited to a memory card, smart card, a radio frequency identification (RFID) device, USB key, magnetic card or other electronic storage device. Typically, the memory device is a credit card, debit card or other card that enables the transfer of monetary credit to the gaming machine 1. Other forms of value include gaming tokens, paper, tickets, vouchers, and any other object representative of value.

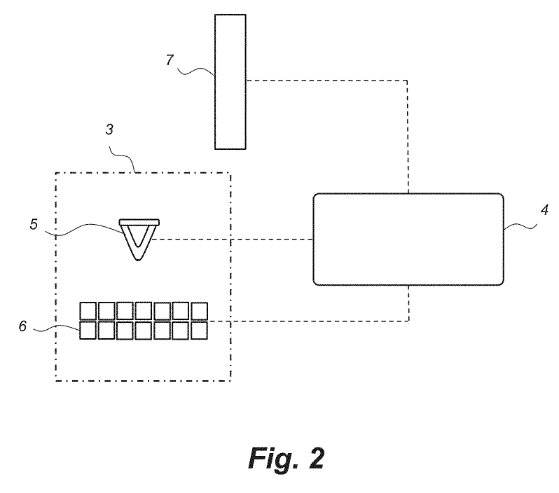

The game controller 4 is generally in the form of an electronic game controller comprising a central processing unit, such as a computer, and is in electronic communication with a display in the form of a video display screen 7, as well as various input devices on the console 3, as best shown in FIG. 2. Typically, the electronic game controller 4 also comprises a random access memory (RAM) associated with the central processing unit, the RAM being used to store program instructions and transient data related to the operation of the electronic game controller and hence the gaming machine 1. The RAM contains a body of program instructions for implementing a game on the gaming machine 1, as discussed in more detail below. The central processing unit or processor may also be operatively associated with a further storage device, such as a hard disk drive, which is used for long-term storage of program components and data relating to the electronic game controller 4 and/or the gaming machine 1, including a database for game performance data, as well as information gathered from users. It is also appreciated that a person skilled in the art would readily understand the location and use of the electronic game controller 4 in the gaming machine 1.

The electronic game controller 4 will transmit and receive signals to and from each of the input devices and the display 7, usually via wired connections but can include wireless modes of electronic communication, such as WLAN. In the case of the vending slots 5 (or with any other type of value transfer mechanism), there may be an intermediate credit verification device that examines and verifies the cash or credits received by the vending slots. Once the value (such as cash or credits) have been verified by the credit verification device, a signal is sent to the electronic game controller 4, which then determines whether the minimum bet level has been reached. If so, the electronic game controller 4 will permits play of the game on the gaming machine 1. If not, the electronic game controller 4 will send a signal to the display 7 to show a message requesting further value to be added to the gaming machine 1.

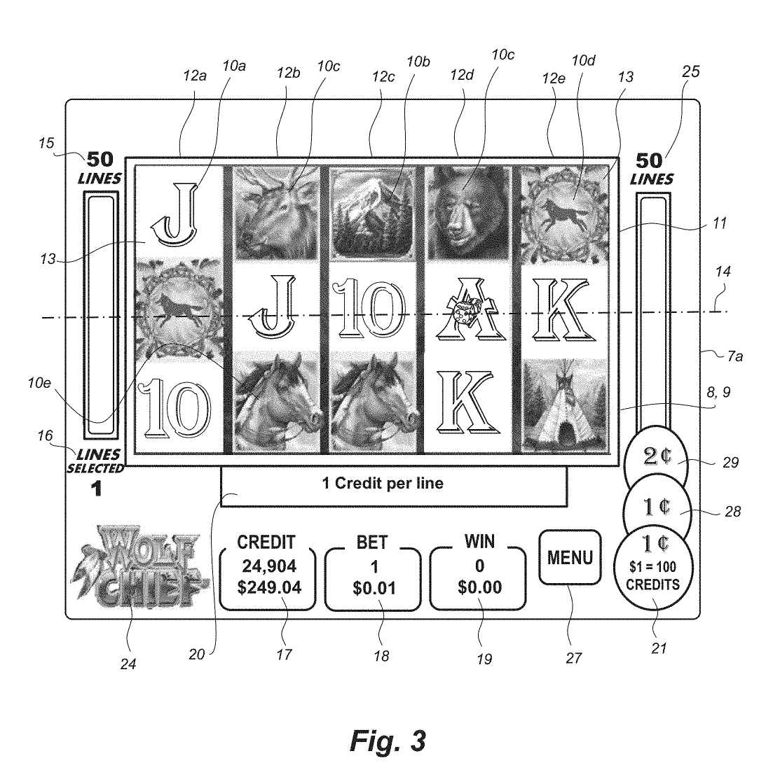

The electronic game controller 4 is programmed to provide a game in the form of a base game 8 (as best shown in FIG. 3) and a feature game 9 on a lower playing area 7a of the display 7 of the gaming machine 1 for play by a player. An upper display area (not shown) is reserved for showing artwork associated with the game(s) that are available for play on the gaming machine and/or other game information. The base game 8 has game symbols 10 arranged into an array 11 in the form of five columns or “reels” 12. The reels 12 give the visual appearance of rotating, typically by having the game symbols 10 move in a downward linear path along the length of each reel 12. While the array 11 is arranged with five reels 12 and three rows as per the industry standard, it will be appreciated by one skilled in the art that other types of arrays could be used, such as 3×3, 4×3, 5×5, 4×4, etc, including arrays having an irregular number of rows and/or columns. For example, the array 11 can have an unequal number of rows and/or columns, where some columns have less or more rows than other columns or where some rows have less or more columns than other rows. A more specific example would be an array having three columns with only two rows and two columns with three rows. The electronic game controller 4 will transmit signals to the display screen 7 to cause the base game 8 and feature game 9 to be played on the lower playing area 7a, including showing the game symbols 10, array 11 and other visible elements of the games.

The array 11 of the base game 8 defines predetermined game or symbol positions 13, in which the game symbols 10 appear. The symbol positions 13 are not visually marked by boundary lines and simply provide an area for the game symbols 10 to appear. However, it will be appreciated that in other embodiments, the symbol positions 13 are defined by visible boundary lines (to define “squares” or game positions) or other markings to define each respective area of the symbol positions.

The array 11 is arranged so that a player can select one or more predetermined “pay lines” 14 defined around the array, which correspond to combinations of the symbol or game positions 13. The pay lines 14 correspond to the lines selected by the player and generally comprise at least one game position or symbol position 13 from each reel 12. The number of pay lines 14 that can be selected by the player depends on the amount of the monetary bet for playing a game on the array 11. In the base game 8, predetermined winning combinations of randomly selected game symbols 10 result in the award of prizes to the player.

The game symbols 10 can include a mixture of picture symbols (such as animal symbols or playing card symbols), word symbols, scatter symbols, substitute or wild card symbols and trigger symbols to trigger the feature game 9. Those skilled in the art will readily understand that a substitute symbol is able to act as any other game symbol, and hence is also known as a “wild card” symbol. Likewise, those skilled in the art will readily understand that a scatter symbol is a symbol that triggers a game event or confers an award without having to appear on a player-selected pay line 14. Similarly, a trigger symbol is a symbol that triggers a game event or confers an award, where the trigger symbol may or may not have to appear in combination and may or may not have to appear on the same player-selected pay line 14. In this embodiment, the game symbols 10 include playing card symbols 10a, animal-themed symbols 10b, item-themed symbols 10c, substitute or wild card symbols in the form of wolf image symbol 10d and a scatter symbol in the form of a horse symbol 10e. The electronic game controller 4 randomly determines the appearance of the game symbols 10 on the array 11.

The video screen 7 also displays other standard game information in the lower playing area 7a, including the number of pay lines available 15, the number of player-selected pay lines 16, the amount of player credits 17, the amount of the current bet wagered by the player 18, the amount of wins by the player 19, a message area 20, a current denomination button 21 indicating the currently selected base bet denomination and the name 24 of the base game 8, “Wolf Chief”™, as best shown in FIG. 3. A menu button 27 for bringing up a menu screen (typically explaining the game rules and showing the available pay lines 14) is also displayed on the video screen 7. Other standard game information may include jackpot information relating to any jackpots the base game 8 and feature game 9 that are awarded by the electronic gaming machine 1. This jackpot information is typically displayed in the upper display area and can comprise, in descending order of monetary value, a grand jackpot, major jackpot, minor jackpot and midi jackpot.

In the base game 8, the player initially makes a bet using vending slots 5 to initiate play of the gaming machine 1 by building up credit to play the base game 8 on the gaming machine. For example, the player can bet or wager monetary amounts equivalent to a particular amount of credits, depending on the bet denomination selected for the base game. Also, the player can make any additional side bets or ante-bets during play of the base game 8 once the base game has commenced to access additional features in the base game, such as increasing the number of winning combinations in the base game.

Typically, gaming machines offer a number of preset bet options that the player can make, and these bet options can vary depending on the game or games offered on the gaming machine. For example, a game on a gaming machine may provide bet options of 1 credit, 2 credits, 5 credits and 10 credits per player-selected pay line 14. In another example, the player may bet 1 credit, 2 credits, 5 credits and 10 credits for a preset group or combination of pay lines 14, such as a group of 5 pay lines, 10 pay lines, 20 pay lines, etc.

The gaming machine 1 also has a default bet denomination, which is usually the bet denomination that was previously used in the preceding play of the base game 8. For example, if a person had played the base game 8 with a bet denomination of 5¢, then this would be the default bet denomination for the player when he or she commences play of the game. Where the gaming machine has not yet been played or has been started up, the default bet denomination is initially selected by the electronic game controller 4. The default bet denomination can be randomly selected or chosen according to a predetermined order. Usually, the electronic game controller 4 will select the bet denomination with the lowest value that is available for the base game 8, which would be the 1¢ bet denomination for this embodiment. The player may change the bet denomination at any time in the base game 8 by touching the denomination button 21 before or after the reels 12 have spun. In this embodiment, touching the denomination button will bring denomination images that the player may select to quickly change the bet denomination between plays of the game 8.

Once the player has commenced play of the game 8 by making an appropriate bet via the vending slots 5, the electronic game controller 4 then commences a play of the base game 8 by sending a signal to the display 7 to cause the reels 12 to appear to visibly rotate or “spin” in a linear path, typically in a downward vertical direction, and randomly display the game symbols 10 in each game position 13 (including the special game positions 30) for each play of the array 11 for the base game 8. After the reels 12 stop spinning (and thus ends the spin or play of the base game 8), the electronic game controller 4 determines whether there are any predetermined winning combinations of the game symbols 10 appearing in any player-selected pay lines 14, such as a two of a kind, three of a kind, four of a kind or five of a kind for all the game symbols 10 and other combinations of a “full house”, “straight” or “flush” for the playing card game symbols 10a. It will be appreciated that other winning combinations of game symbols 10 can also be provided. If so, the gaming machine 1 enters a winning game state and awards a prize according to the displayed predetermined winning combination.

The electronic game controller 4 also determines whether the feature game 9 should be activated, based on a predetermined trigger event, such as the appearance of a number of trigger symbols appearing in a play or spin of the base game 8. In this embodiment, the trigger event is the appearance of three scatter symbols 10d. The scatter symbols 10d need not appear on the same pay line 14, but can appear on any of the player-selected pay lines.

In response to the trigger event, the electronic game controller 4 then transmits a signal to the video screen 7 to cause the feature game 9 to appear on the video screen 7. The feature game 9 also uses the same game symbols 10 as the base game 8, as well as the same array 11, reels 12a to 12e, symbol positions 13 and player-selectable pay lines 14 on the video screen 7. As such, the feature game 9 appears visually the same as the base game 8, and so is also effectively illustrated by FIG. 3.

In the feature game 9, ten free plays or spins of the feature game are awarded to the player without having to make an additional bet or wager. It will be understood by those skilled in the art that a free play or spin involves a play of the game without requiring any bet to be made by the player, and that any number of free spins can be chosen for the feature game 9. In addition, it will be appreciated that in the art free spins are commonly referred to as “free games”. The number of free games remaining in the feature game 9 is indicated by a counter 51. Typically, the prizes awarded for the same winning combinations of game symbols in the feature game 9 are of higher value than the prizes awarded in the base game 8.

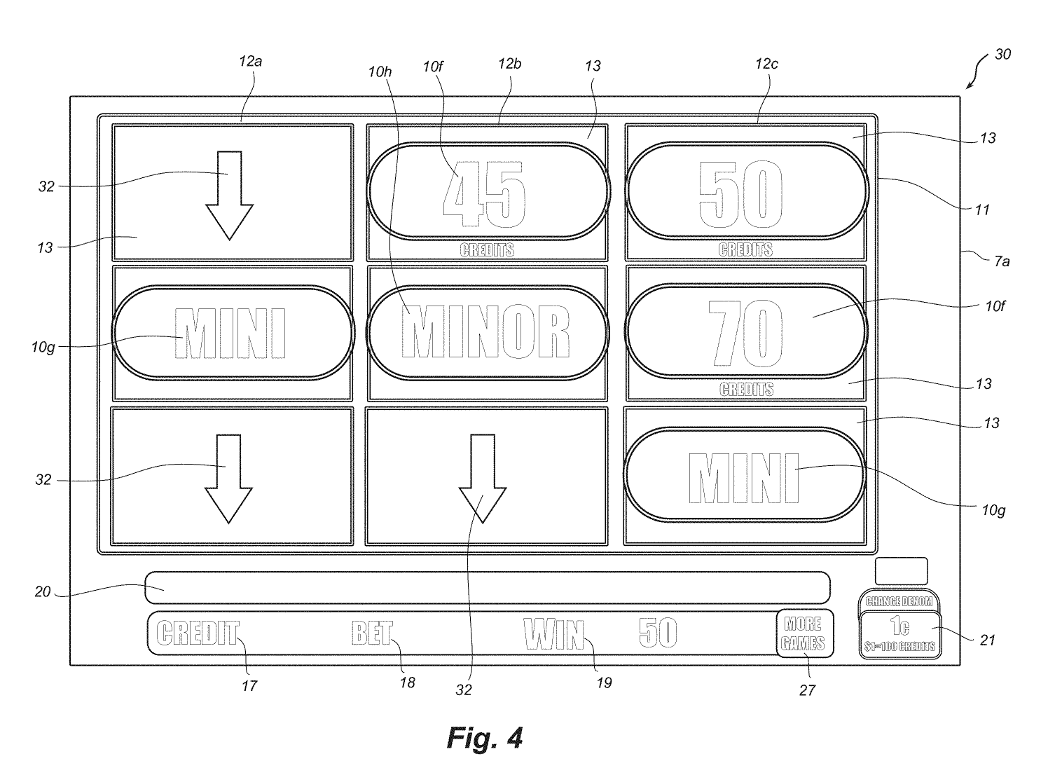

Referring to FIG. 4, another base game 30 played on the electronic gaming machine 1 is partly illustrated, where extraneous features, such as standard game information relating to the number of pay lines available 15 and the number of player-selected pay lines 16, have been removed for the purposes of clarity. In this embodiment, the array 11 is a 3×3 array, with each symbol position 13 comprising its own individual reel and three of the reels are grouped into columns 12a to 12c of reels. That is, each symbol position 13 has its own individual reel strip of game symbols. In other embodiments, the symbol positions 13 are not individual reels but are grouped to form three reels 12a to 12c, where the same reel strip is used to randomly select and display game symbols of each reel 12a to 12c. The reel strips for the game 30 do not have a game symbol 10g to 10h for each position of the reel strip, but instead have empty positions or “blanks” that do not show any game symbol. Alternatively, there are null symbols or terminator symbols in the reel strips that cannot form part of any winning combination of symbols but simply act to end the base game 30.

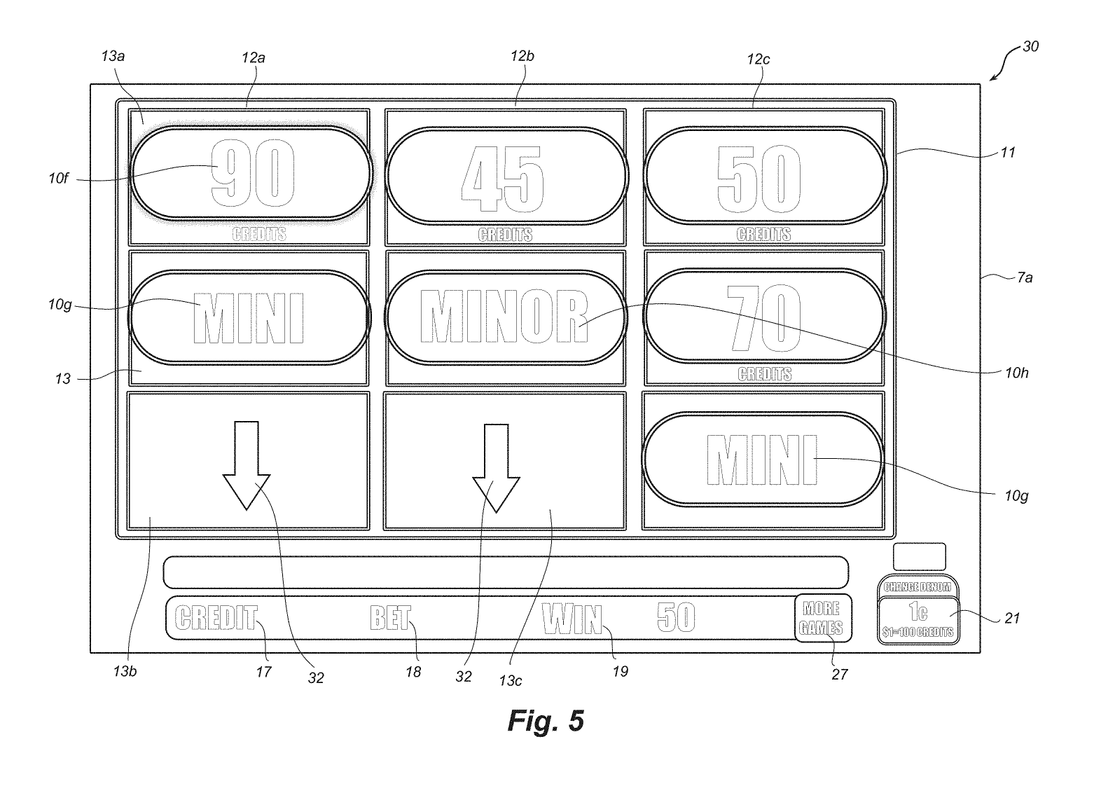

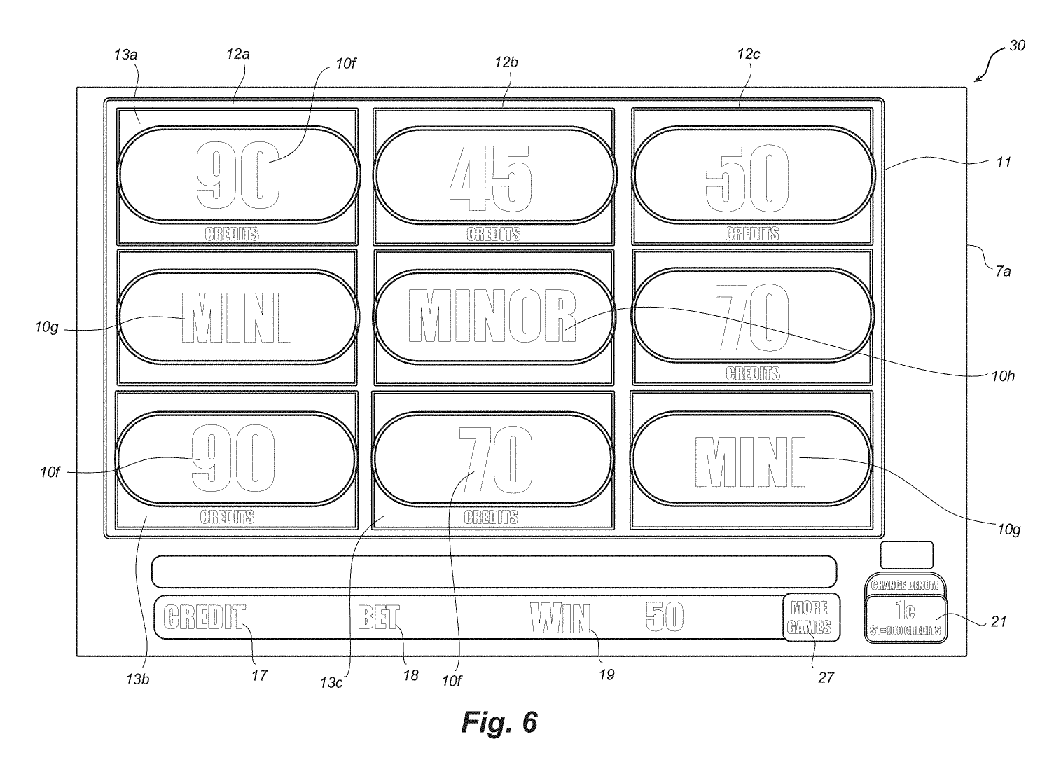

In FIG. 4, the reels in the symbol positions 13 spin at different rates so that some symbol positions 13 display the result of the spin of their reels (displaying game symbols 10f, 10g, 10h or an empty position) while other symbol positions are still spinning as indicated schematically by arrows 32. In FIG. 5, the reel in the symbol position 13a has stopped spinning to show a “90 credits” game symbol 10f while two remaining reels in symbol positions 13b and 13c remain spinning. In FIG. 6, the last two reels in symbol positions 13b and 13c have stopped to display “90 credits” and “70 credits” game symbols 10f in their respective positions. While in FIGS. 4 to 6, a game symbol 10f to 10h has been displayed in each of the symbol positions 13, it is possible through random selection by the electronic game controller 4 that one or more of the symbol positions 13 are left vacant.

If one of the symbol positions 13 did not display a game symbol 10f to 10h, then the base game 30 ends and the player has to make another bet to commence play of the base game 30 and spin each reel in the symbol positions 13 in the array 11. However, the player is awarded prizes based on any winning combinations of game symbols 10f to 10h that are displayed in the symbol positions 13 in the array before the base game 30 ends. In this embodiment, the winning combinations are the accumulated game symbols 10f that have numerical values and any three of a kind of the MINI game symbol 10g and MINOR game symbol 10h. For example, if the last two remaining reels did not display a game symbol 10f to 10h in their respective symbol positions 13b, 13c as shown in FIG. 5, then the player would only receive a prize of 255 credits (being the sum of the displayed credit game symbols 10f, being on of 45, 50, 70 and 90 credits) and not the MINI or MINOR bonus prize as there are not three of a kind of each symbol displayed.

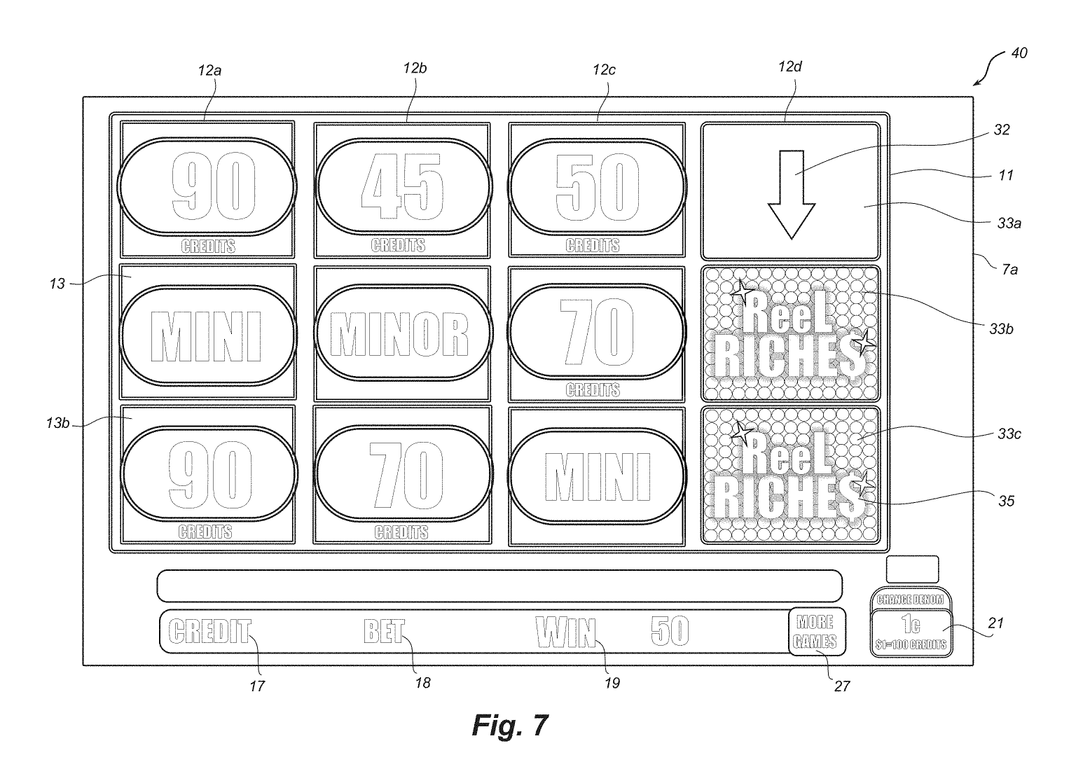

The display of a game symbol 10f to 10h in each symbol position 13 of the array 11 is a trigger event that causes the display of a feature game 40, as best shown in FIG. 7. In addition, the player is not yet awarded a prize based on the displayed game symbols 10f to 10h in the array 11. Instead, the award of the prize is delayed until later in the game, as discussed in more detail below.

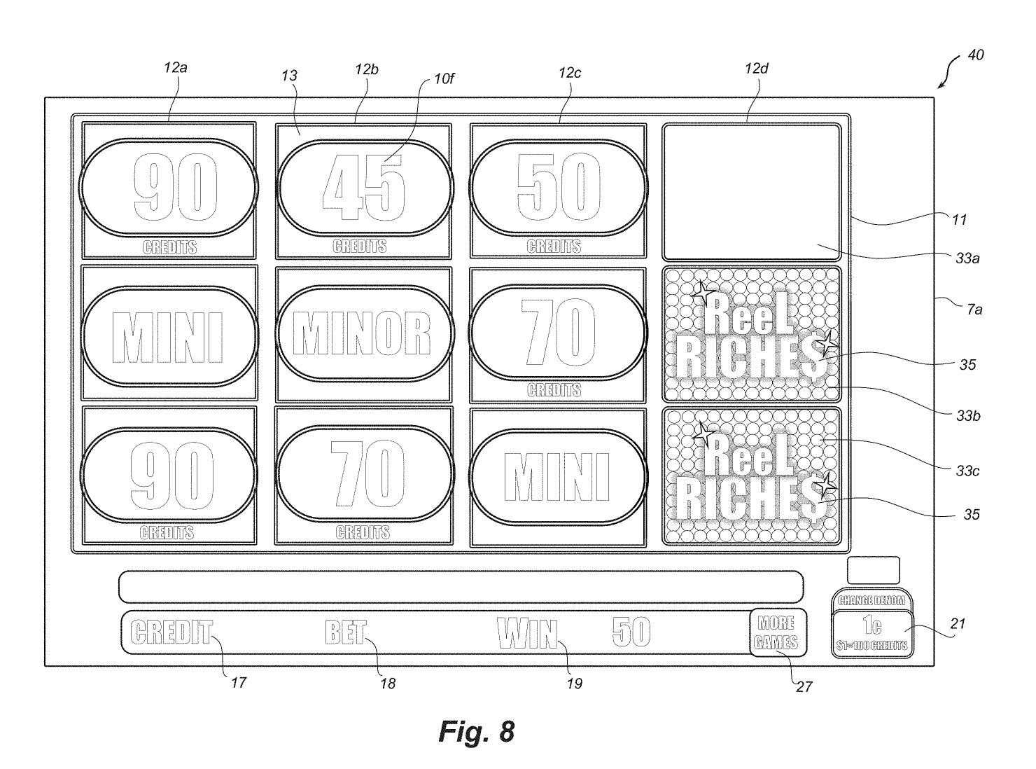

In the feature game 40, the columns 12a to 12c of reels are held static (in the sense that the reels in symbol positions 13 do not spin and the game symbols 10f to 10h remain displayed in the symbol positions 13) and another column 12d of reels is displayed so as to extend the array 11 to be a 4×3 array. The column 12d of reels comprises symbol positions 33 that are in addition to the existing symbol positions 13 in the array 11. The symbol positions 33 have their own individual reels that spin sequentially (i.e. one after the other), beginning from the top symbol position 33a. As can be seen, the top symbol position 33a has its reel spinning as indicated by arrow 32 while the two symbol positions 33b, 33c have not yet spun and are displaying non-game image symbols 35 (in this case, showing an image of the name of the game, being “Reel Riches”). Once the reel in the top symbol position 33a completes its spin, as best shown in FIG. 8, the next reel in the middle symbol position 33b commences its spin if a game symbol 10f to 10h appears. In this case, the bottom symbol position 33c does not spin but displays the non-game image symbol 35. Once the middle symbol position 33b completes its spin, the next reel in the bottom symbol position 33c commences its spin. Finally, the last reel in the bottom symbol position 33c ends its spin.

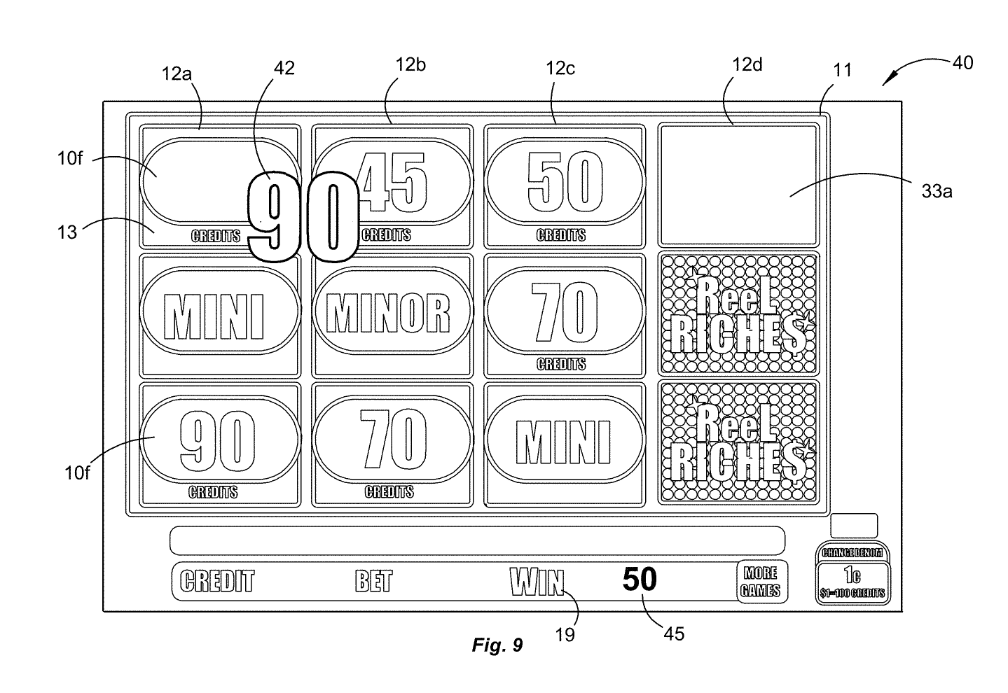

As described above, as each symbol position 33 spins, the electronic game controller 4 randomly determines whether a game symbol 10f to 10h is to be displayed in that symbol position 33. Where the electronic game controller 4 randomly determines that a game symbol 10f to 10h should not be displayed in one or more of the symbol positions 33, then that symbol position 33 remains empty or left vacant, as best shown in FIG. 9.

If one of the symbol positions 33a to 33c does not display a game symbol 10f to 10h, then the feature game 40 ends and the electronic gaming machine 1 resets to display the base game 30. The player now has to make another bet to commence play of the base game 30 and spin each reel in the symbol positions 13 in the array 11. However, the player is awarded prizes based on any winning combinations of game symbols 10f to 10h that are displayed in the symbol positions 13, 33 in the array 11 before the feature game 40 ends. As shown in FIG. 9, the top reel position 33a did not display a game symbol 10f to 10h and so the player only receives a prize of 415 credits (being the sum of the displayed credit game symbols 10f in the symbol positions 13, 33) and not the MINI or MINOR bonus prize as there are not three of a kind of each symbol displayed.

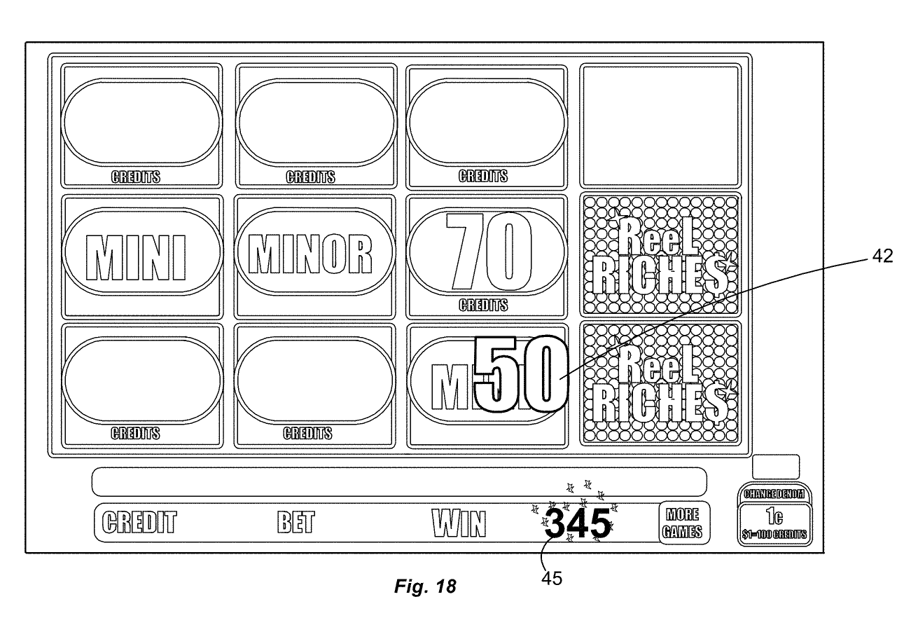

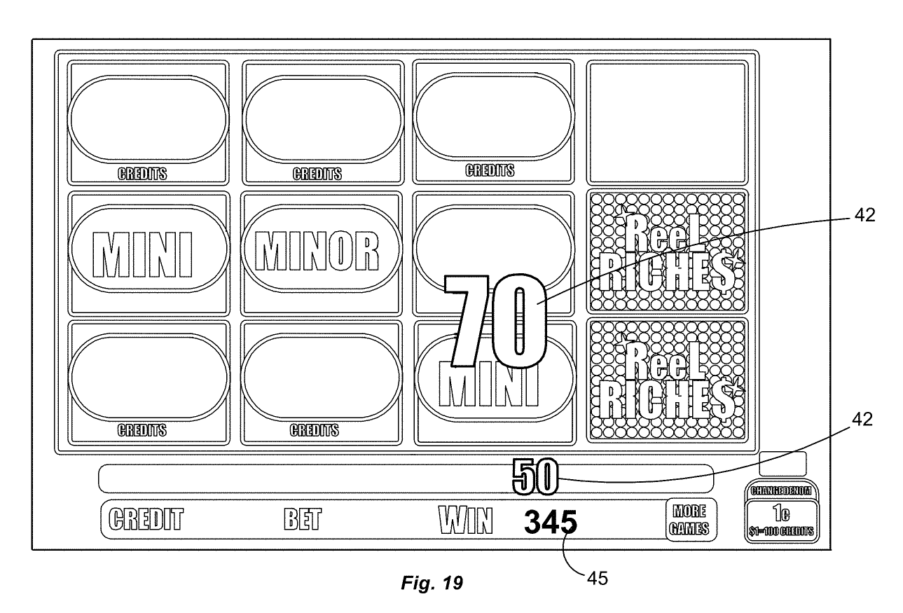

Referring to FIGS. 9 to 24, the prize is awarded to the player using an animated sequence involving symbol meters 42 is associated with each of the game symbols 10f. In this embodiment, the symbol meter 42 is the same as its value, and is the shown credit amount that forms part of each game symbol 10f. However, in other embodiments, it will be appreciated that the symbol meter is not necessarily integrated with the game symbol 10f but is displayed adjacent the game symbol. Also, in some embodiments, the symbol meter 42 comprises a graphical element indicating its general level and does not show its numerical value.

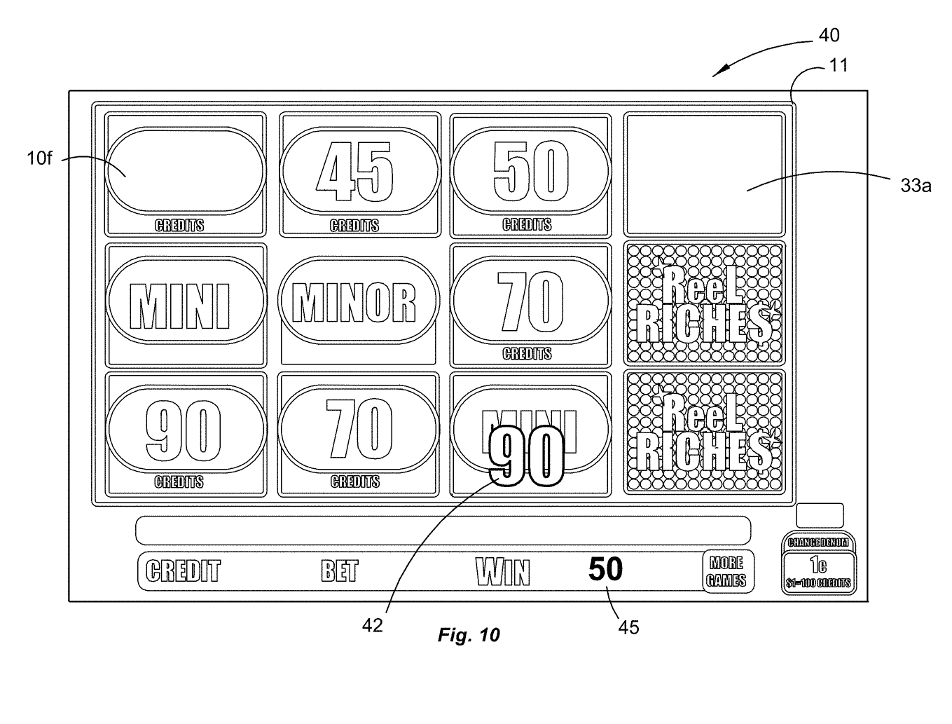

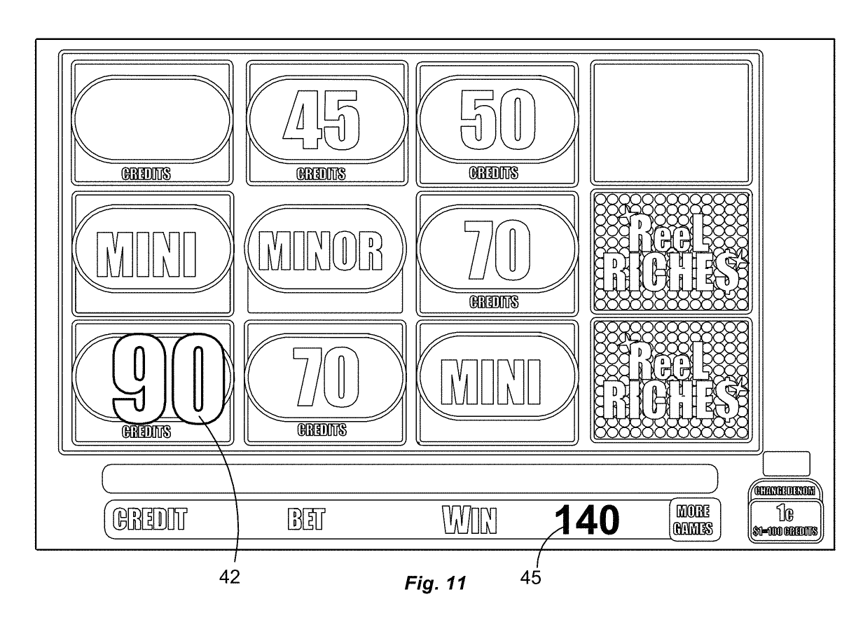

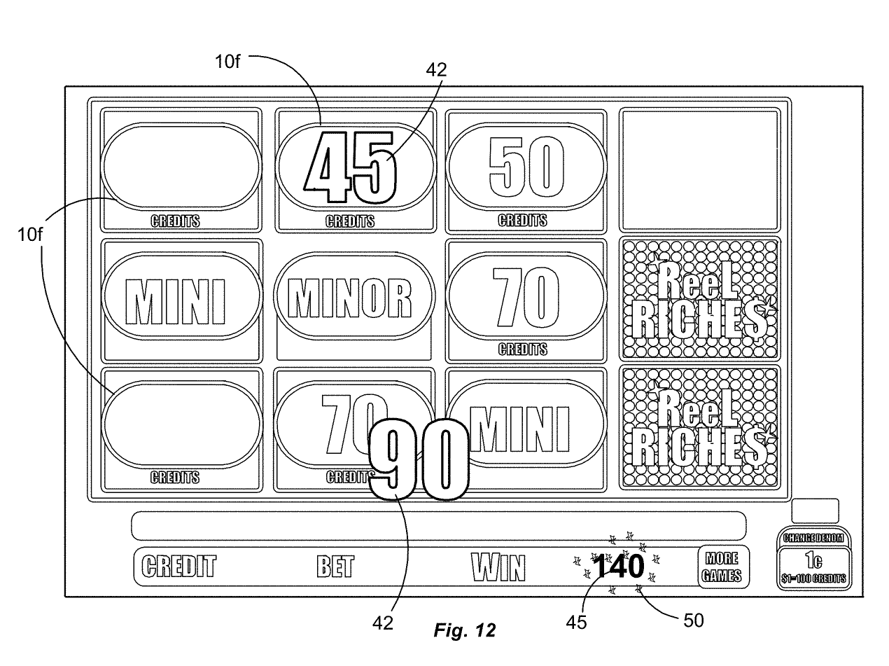

In FIG. 9, the symbol meter 42 moves out of the game symbol 10f and symbol position 13 towards a win meter 45 of the win amount indicator 19. As it moves, the symbol meter 42 initially increases or expands in size to highlight its movement towards the win meter 45. As it moves the symbol meter 42 changes in size, gradually shrinking or reducing in size at it approaches the win meter 45, as best shown in FIG. 10. When the symbol meter 42 “hits” or arrives at the win meter 45, the win meter increases or expands in size and increments from its base amount 50 (the amount won in the base game 30 prior to triggering the feature game 40) up to added value of the symbol meter 42, as best shown in FIG. 11. Thus, the win meter 45 increases from the base value of 50 credits to 140 credits (corresponding to an increase of 90 credits corresponding to the value of the symbol meter 42). After initially expanding, the win meter 45 then decreases in size to return to its original size, as best shown in FIG. 12. Also, as shown in that figure, the expansion and contraction of the win meter 45 is accompanied by an audiovisual presentation or animation, which in this embodiment is the appearance of “sparkles” 50 (or a particle effect) to highlight the increase in the win meter 45.

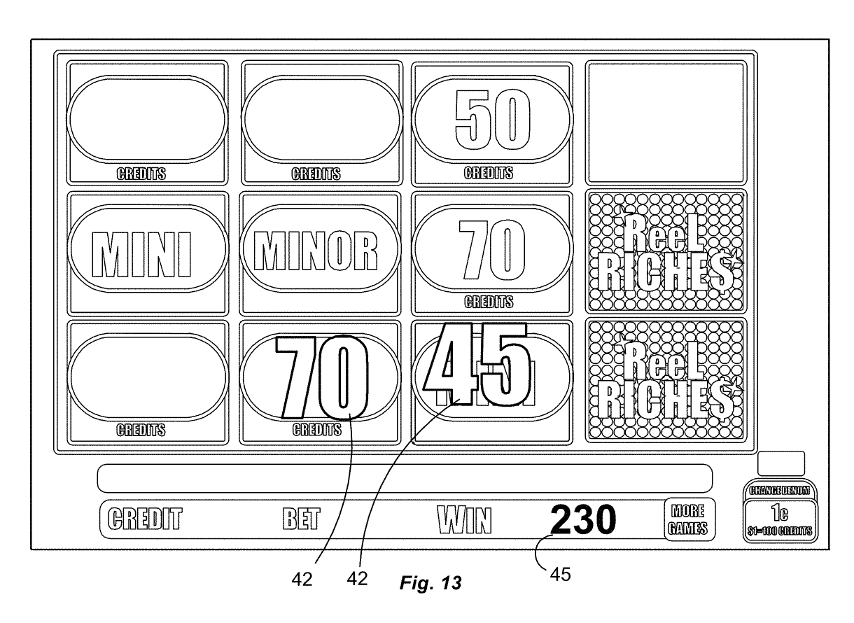

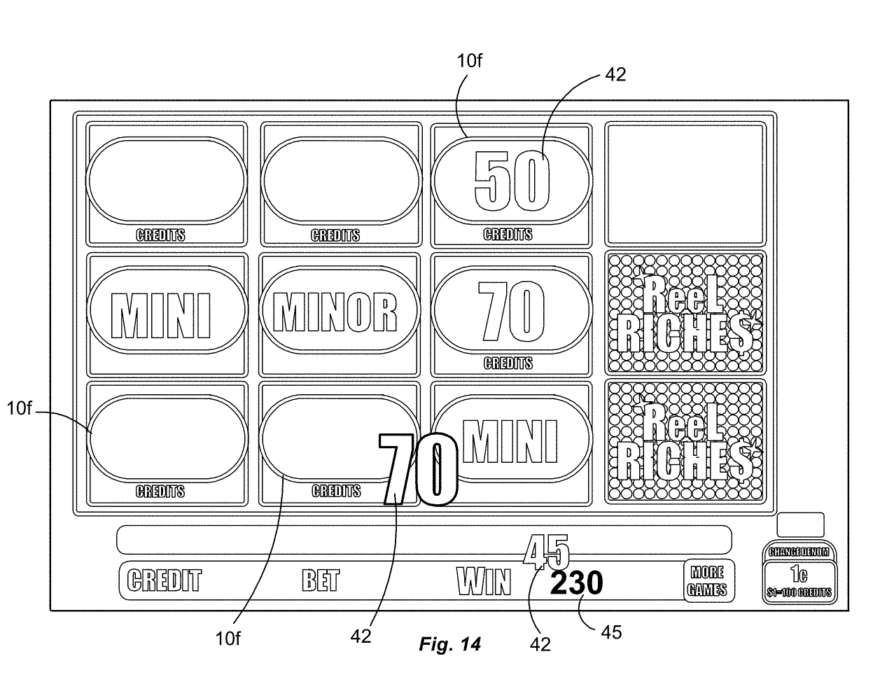

This animated sequence is repeated for each symbol meter 42 of each game symbol 10f that results in an awarded prize. As best shown in FIGS. 11 and 12, the next symbol meter 42 having a value of 90 begins to move towards and hits the win meter 45 to increase its value to 230 credits by the amount of 90 credits, as best shown in FIG. 13. Also, the win meter 45 expands in size in response to the increase in its value, as best shown in FIG. 13 and then contracts to its original size, as best shown in FIG. 14.

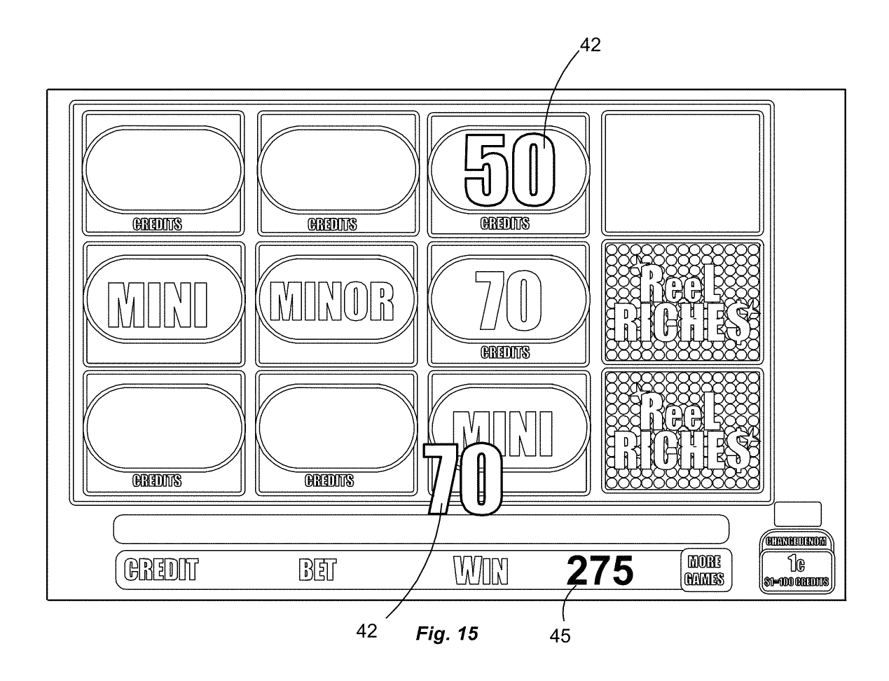

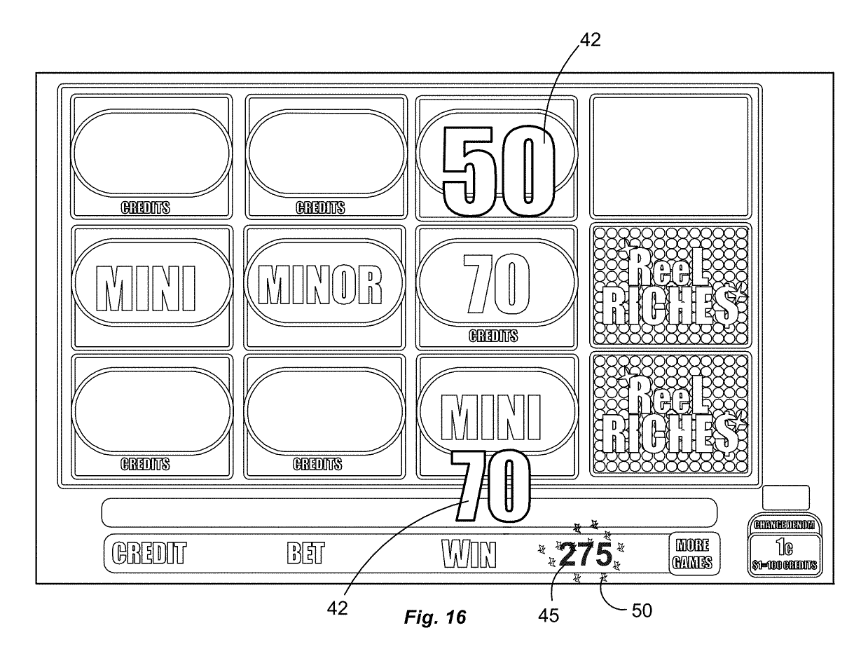

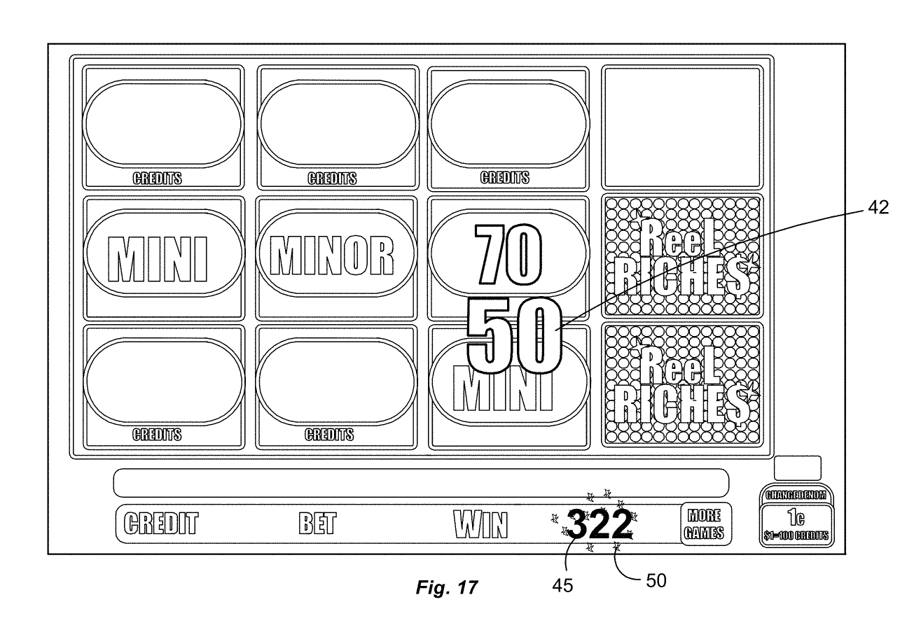

The other symbol meters 42 having values of 45 and 70 also move, as shown in FIGS. 13 and 14. The symbol meter 42 having a value of 45 increases to win meter 45 to 275 credits (as best shown in FIGS. 15 and 16) while the symbol meter 42 having a value of 70 increases to win meter 45 to 345 credits (as best shown in FIG. 18). Again, the win meter 45 expands and contracts in size as it increases in value to 275 credits as shown in FIGS. 15 and 16, and again in value to 345 credits in FIGS. 16 to 19. Also, win meter 45 is shown with the sparkles 50 in FIGS. 16 to 18. Referring to FIG. 17, the incrementing of the win meter 45 up to the increased value is shown to the player to increase the entertainment value in the animated sequence. In this example, the win meter 45 shows an intermediate value of 322 credits as it increments up to the calculated value of 345 credits.

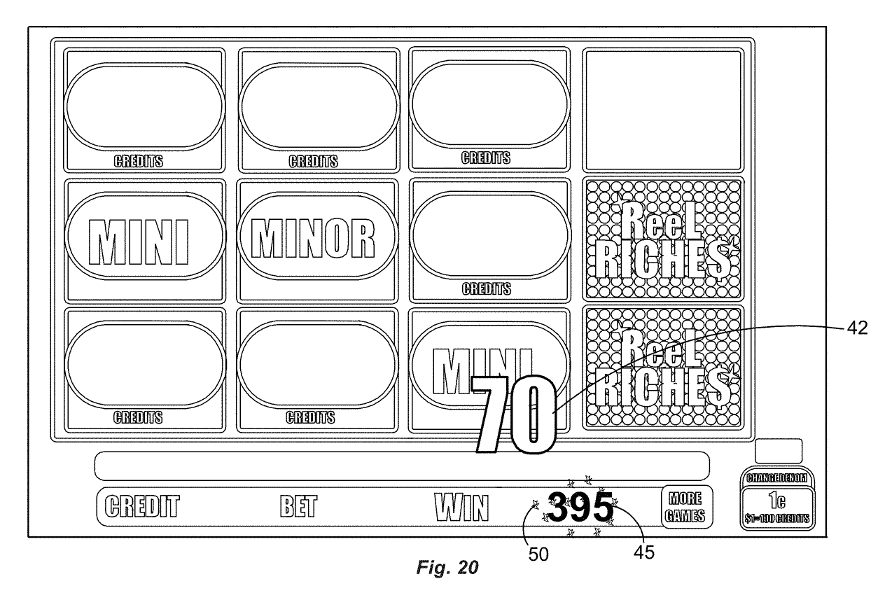

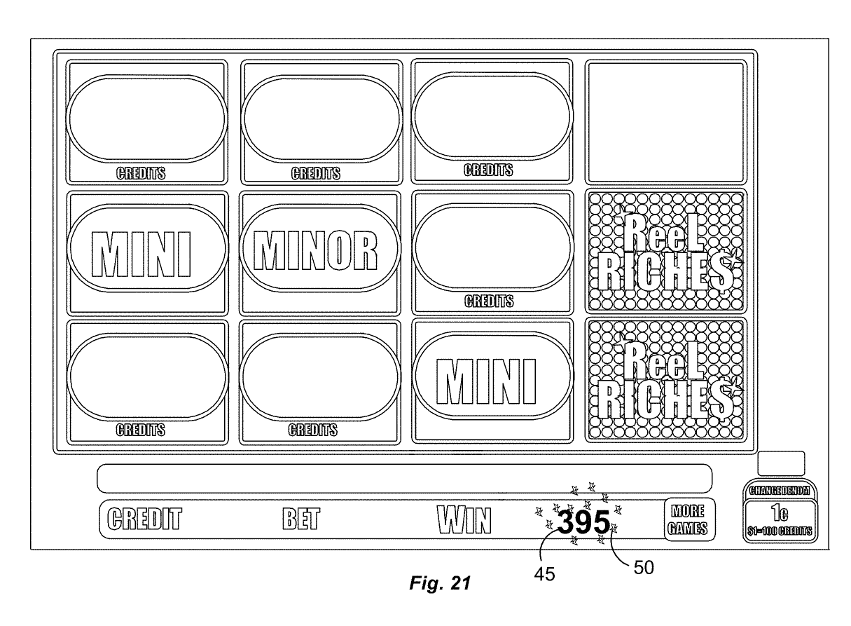

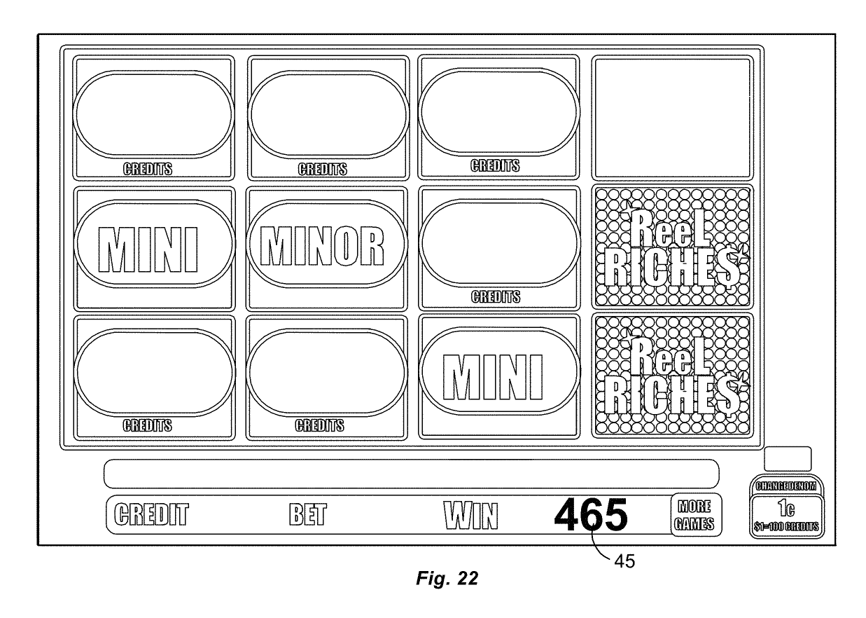

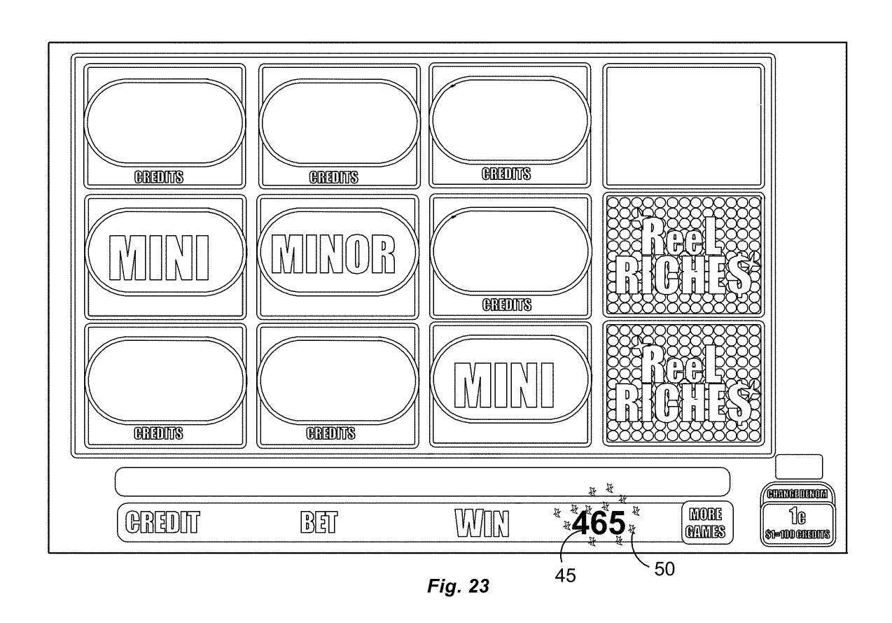

In FIGS. 15 to 19, the next symbol meter 42 having a value of 50 moves out from the game symbol 10f in symbol position 13 towards the win meter 45, as does the final symbol meter 42 having a value of 70 in FIGS. 17 to 20. In FIG. 20, the win meter 45 increases in value to 395 credits as it is hit by the symbol meter 42 having a value of 50, as well as expanding in size and being accompanied by the sparkles 50. In FIG. 21, the symbol meter 42 has just hit the win meter while the sparkles 50 from the previous increase are still present. In FIG. 22, the win meter 45 increases in value to 465 credits and expands in size, while in FIG. 23 the win meter 45 shows the sparkles 50 and in FIG. 24, the win meter 45 has returned to its original size.

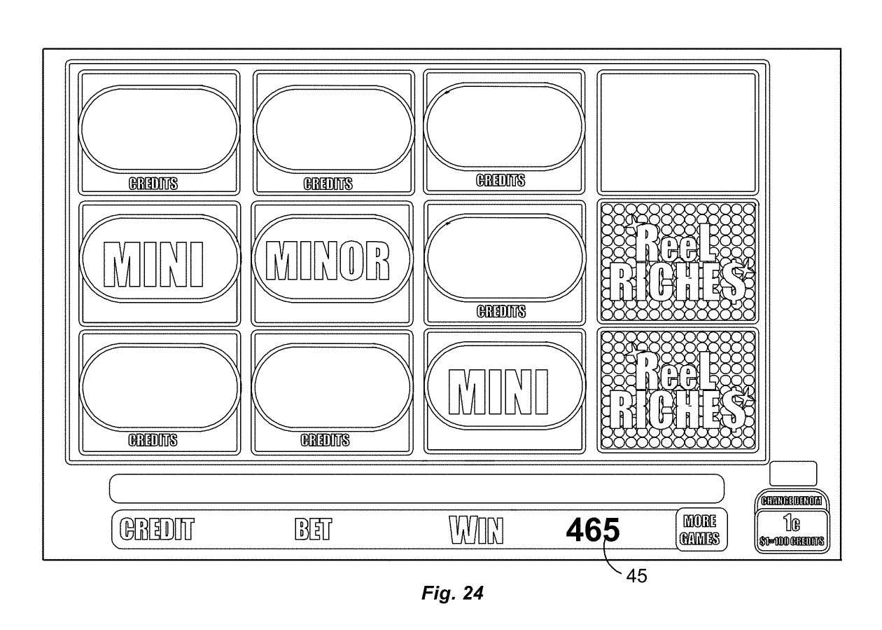

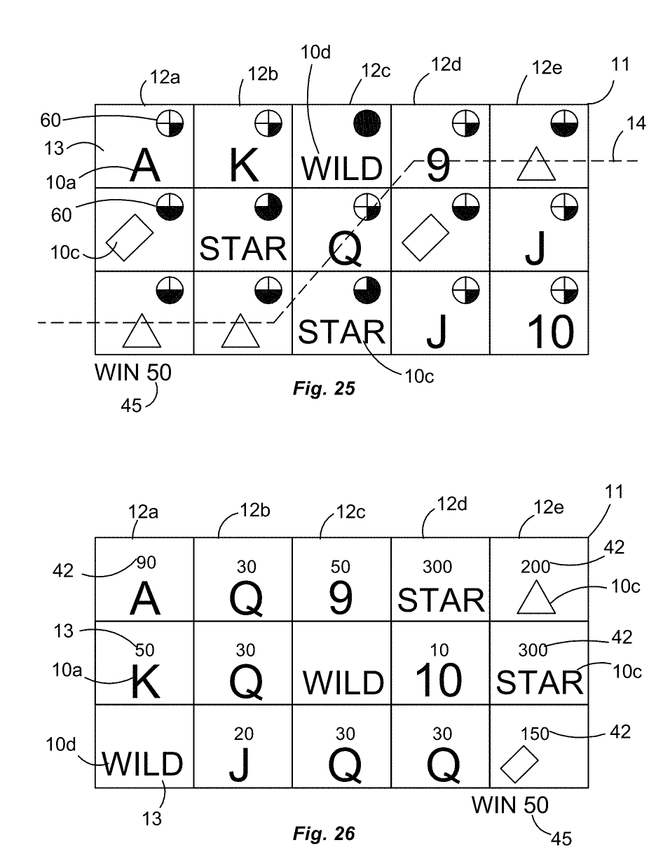

Referring to FIG. 25, a further embodiment is shown, where the symbol meter does not comprise its value but is shown as a circular gauge 60 adjacent the game symbols 10 on the array 11. In this way, the player can visually determine at a glance which game symbols have greater value by reference to their respective gauges 60. For example, the playing card symbols 10a all have the same gauge 60 showing a quarter filled in circle, the item-based triangle and oblong symbols 10c have the same gauge 60 showing a half filled in circle while the item-based START symbol 10c has gauge 60 showing a three-quarter filled in circle and the WILD symbol 10d has a gauge 60 showing a fully filled in circle. Thus, the player can quickly determine which symbols 10 have the most value and hence attract higher value prizes.

Referring to FIG. 26, yet another embodiment is shown where the symbol meter 42 comprises its value but is shown adjacent the game symbols 10 displayed on the array 11. In this embodiment, the playing card symbols 10a have different symbol meters to indicate a hierarchy of values, with the Ace symbol 10a having a higher value symbol meter 42 of 90 compared to the King symbol (symbol meter 42 having a value of 50), the Queen symbol (symbol meter 42 having a value of 30), Jack symbol (symbol meter 42 having a value of 20), the ten symbol (symbol meter 42 having a value of 10) and the nine symbol (symbol meter 42 having a value of 5). Similarly, the item-based oblong, triangle and STAR symbols 10c having symbols meters 42 with gradually ascending values 150, 200 and 300. Due to its nature as a substitute symbol, the WILD symbol 10d does not have a gauge.

In the embodiments of FIGS. 25 and 26, the gauges 60 and symbol meters 42 will move from their displayed positions to the win meter 45 in the same manner as described above in relation to FIGS. 9 to 24 when winning combinations are formed using their associated game symbols 10. Moreover, it will be appreciated that the symbol meter 42 can take different visual forms aside from simple values or circle shaped gauges 60, such as a column gauge, a flower bud that gradually flowers or other visual indicator.

The ability to provide individual symbol meters 42 for the game symbols 10 permits that the volatility of the game can be readily changed without changing other aspects of the game or its game play. In this way, there is more freedom for the game designer to tailor the gaming machine to a desired volatility without affecting the overall game design. It will be appreciated that one skilled in the art will recognise that the term “volatility” refers to the expected frequency of winning game events occurring and the corresponding amount paid for each winning game event in order to maintain the required payout level set for the gaming machine. Thus, the amount paid for each winning combination and the level of return to the player determines the “volatility” of the gaming machine. For example, a gaming machine with low volatility is configured to have a relatively high frequency of “wins”, where each win has a relatively low value. Conversely, high volatility refers to a lower frequency of “wins” of correspondingly higher value. Throughout the specification, “volatility” is a reference to this characteristic of a gaming machine.

While the preferred embodiments have been described as providing or associating symbol meters 42, 60 with the game symbols displayed on the array 11, it will be appreciated that in other embodiments the symbol meters can be associated with all the game symbols in the game and not just the game symbols on the array 11. Likewise, the symbol meters 42, 60 in some embodiments are associated with some but not all the game symbols 10 in the game.

It will also be appreciated that the display of the symbol meters 42, the movement of the symbol meters 42 and the variation in size of the win meter 45 can be enhanced by suitable animations, visual and/or audio effects. It is contemplated that the enhanced is in particular achieved using three-dimensional images or effects to provide a greater contrast to the two-dimensional display of the rest of the game.

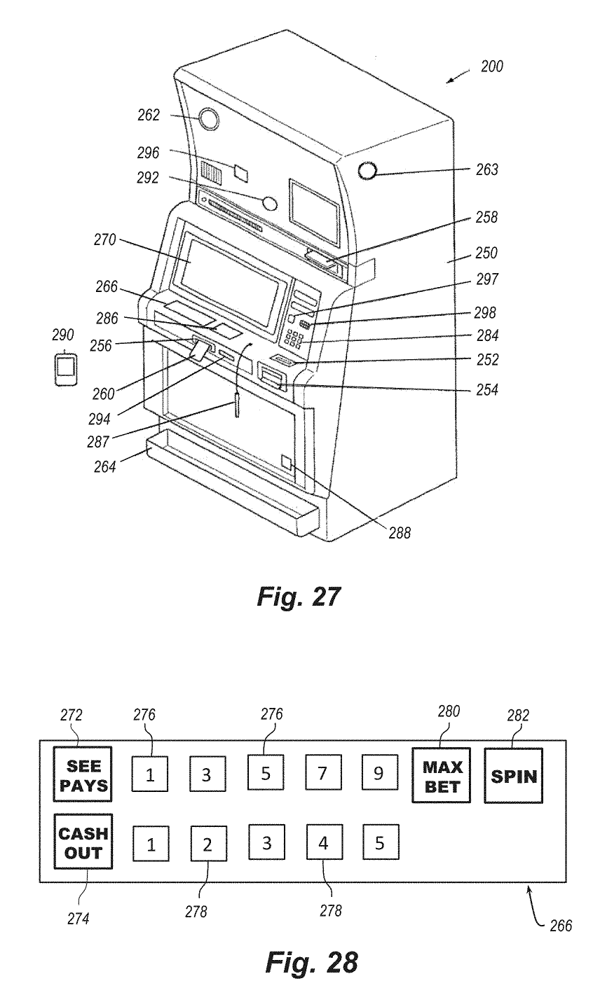

Referring to FIG. 27, another embodiment of the invention is shown in the form of an electronic gaming machine 200. The electronic gaming machine 200 may include a housing or cabinet 250 and one or more value transfer mechanisms or devices, which may include a coin slot or acceptor 252, a paper currency or bill acceptor 254, a ticket reader/printer 256 and a card reader 258, which may be used to input value to the electronic gaming machine 200. A value transfer device may include any device that can accept value from a player. The topper (not shown) may be mounted to the top of the electronic gaming machine 200.

If provided on the electronic gaming machine 200, the ticket reader/printer 256 may be used to read and/or print or otherwise encode ticket vouchers 260. The ticket vouchers 260 may be composed of paper or another printable or encodable material and may have one or more of the following informational items printed or encoded thereon: the casino name, the type of ticket voucher, a validation number, a bar code with control and/or security data, the date and time of issuance of the ticket voucher, redemption instructions and restrictions, a description of an award, and any other information that may be necessary or desirable. Different types of ticket vouchers 260 could be used, such as bonus ticket vouchers, cash-redemption ticket vouchers, casino chip ticket vouchers, extra game play ticket vouchers, merchandise ticket vouchers, restaurant ticket vouchers, show ticket vouchers, etc. The ticket vouchers 260 could be printed with an optically readable material such as ink, or data on the ticket vouchers 260 could be magnetically encoded. The ticket reader/printer 256 may be provided with the ability to both read and print ticket vouchers 260, or it may be provided with the ability to only read or only print or encode ticket vouchers 260. In the latter case, for example, some of the electronic gaming machines 200 may have ticket printers 256 that may be used to print ticket vouchers 260, which could then be used by a player in other electronic gaming machines 200 that have ticket readers 256.

If provided, the card reader 258 may include any type of card reading device, such as a magnetic card reader or an optical card reader, and may be used to read data from a card offered by a player, such as a credit card or a player tracking card. If provided for player tracking purposes, the card reader 258 may be used to read data from, and/or write data to, player tracking cards that are capable of storing data representing the identity of a player, the identity of a casino, the player's gaming habits, etc.

The electronic gaming machine 200 may include one or more audio speakers 262, a coin payout tray 264, an input control panel 266, and a colour video display unit 270 for displaying images relating to the game or games provided by the electronic gaming machine 200. The audio speakers 262 may generate audio representing sounds such as the noise of spinning reels, a dealer's voice, music, announcements or any other audio related to a game. The input control panel 266 may be provided with a plurality of pushbuttons or touch-sensitive areas that may be pressed by a player to select games, make wagers, make gaming decisions, etc.

FIG. 28 illustrates one possible embodiment of the control panel 266, which may be used where the electronic gaming machine 200 having a plurality of reels. The control panel 266 may include a “See Pays” button 272 that, when activated, causes the display unit 270 to generate one or more display screens showing the odds or payout information for the game or games provided by the electronic gaming machine 200. As used herein, the term “button” is intended to encompass any device that allows a player to make an input, such as an input device that must be depressed to make an input selection or a display area that a player may simply touch. The control panel 266 may include a “Cash Out” button 274 that may be activated when a player decides to terminate play on the electronic gaming machine 200, in which case the electronic gaming machine 200 may return value to the player, such as by returning a number of coins to the player via the payout tray 264.

The control panel 266 may be provided with a plurality of selection buttons 276, each of which allows the player to select a different number of pay lines prior to spinning the reels. For example, five buttons 276 may be provided, each of which may allow a player to select one, three, five, seven or nine pay lines.

The control panel 266 may also be provided with a plurality of selection buttons 78 each of which allows a player to specify a wager amount for each pay line selected. For example, the electronic gaming machine 200 may be provided with five selection buttons 78, each of which may allow a player to select 1¢, 2¢, 5¢, 10¢ and 20¢, to wager for each pay line selected. In that case, if a player were to activate one of the buttons 276 to select five pay lines and then activate one of the buttons 278 to select 5¢ per pay line to be wagered or bet, the total wager would be $0.25.

The control panel 266 may include a “Max Bet” button 280 to allow a player to make the maximum wager allowable for a game. In the above example, where up to nine pay lines were provided and up to 20¢ could be wagered for each pay line selected, the maximum wager would be $1.80 The control panel 266 may include a spin button 282 to allow the player to initiate spinning of the reels after a bet has been made.

In FIG. 28, a rectangle is shown around the buttons 272, 274, 276, 278, 280, 282. It should be understood that the rectangle simply designates, for ease of reference, an area in which the buttons 272, 274, 276, 278, 280, 282 may be located. Consequently, the term “control panel” should not be construed to imply that a panel or plate separate from the housing 250 of the electronic gaming machine 200 is required, and the term “control panel” may encompass a plurality or grouping of player activatable buttons.

Although one possible control panel 266 is described above, it should be understood that different buttons could be utilized in the control panel 266, and that the particular buttons used may depend on the game or games that could be played on the electronic gaming machine 200. Although the control panel 266 is shown to be separate from the display unit 270, it should be understood that the control panel 266 could be generated by the display unit 270. In that case, each of the buttons of the control panel 266 could be a coloured area generated by the display unit 270, and some type of mechanism may be associated with the display unit 270 to detect when each of the buttons was touched, such as a touch-sensitive screen.

As noted above, the electronic gaming machine 200 may include a mechanism by which the electronic gaming machine 200 may determine the identity of the player. In particular, the card reader 258 may be used to read a card that carries an identification code that may be uniquely associated with the player so that the gaming unit can differentiate that player from all other players, or so that the gaming unit can differentiate that player as a member of a group of players from all player not a member of the group of players. The electronic gaming machine 200 may also include equipment, such as a keypad 284, an input pad 286 (with optional stylus 287), a port (or antenna) 288 adapted to communicate via a wired or wireless link (infrared or radio frequency link, for example) to a mobile electronic device 290 (such as a personal digital assistant, smart phone or tablet), a camera 292, a scanner 294, a retinal (or iris) scanner 296, fingerprint scanner 297, and/or a microphone 298. The electronic gaming machine 200 may include any one of the devices 258, 284, 286, 288, 290, 292, 294, 296, 297, 298, or the electronic gaming machine 200 may include a combination of some or all of the devices 258, 284, 286, 287, 288, 290, 292, 294, 296, 297, 298.

In operation, a player may identify him or herself to the electronic gaming machine 200 by entering a unique numeric or alpha-numeric code using the key pad 284, for example. Alternatively, the player may use his or her finger or the stylus 287 to sign his or her signature on the input pad 286. As a further alternative, the player may sign his or her signature on the mobile electronic device 290, which signature is then converted to electronic data, and the data is then transferred via the port/antenna 288 to the electronic gaming machine 200. As yet another alternative, the player may sign his or her signature on a piece of paper that is then photographed using the camera 292 or scanned using the scanner 294 (or the bill acceptor 254) to convert the signature into electronic data. As an additional alternative, the player may place one of his or her fingers or his or her hand on the scanner 297, and the scanner 297 may generate an electronic data representation of the fingerprint on one or more of the player's fingers or an electronic data representation of the pattern of the entire hand. Alternatively, the camera 292 may be used to take a picture (live or still) of the player, the picture then being converted into electronic data. As a still further alternative, the player may place his or her eye up to the retinal (or iris) scanner 296, and the retinal (or iris) scanner 296 may generate an electronic data representation corresponding to the pattern of the retina (or iris) of the player. As yet another alternative, the player may speak into the microphone 298, and characteristics of the spoken words (or voiceprint) may be converted into an electronic data representation.

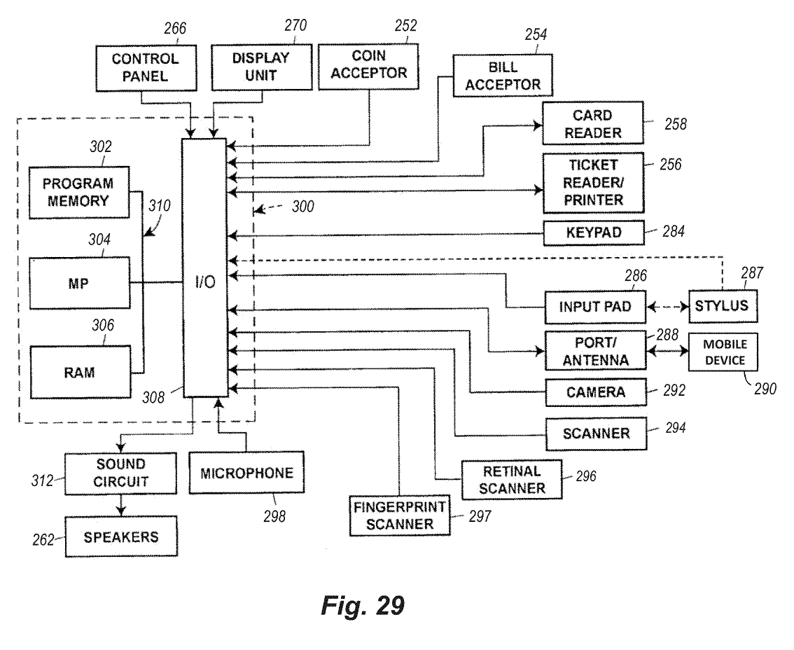

FIG. 29 is a block diagram of a number of components that may be incorporated in the electronic gaming machine 200. Referring to FIG. 29, the electronic gaming machine 200 may include a controller 300 that may comprise a program memory 302, a microcontroller or microprocessor (MP) 304, a random-access memory (RAM) 306 and an input/output (I/O) circuit 308, all of which may be interconnected via an address/data bus 310. It should be appreciated that although only one microprocessor 304 is shown, the controller 300 may include multiple microprocessors 304. Similarly, the memory of the controller 300 may include multiple RAMs 306 and multiple program memories 302. Although the I/O circuit 108 is shown as a single block, it should be appreciated that the I/O circuit 308 may include a number of different types of I/O circuits. The RAM(s) 304 and program memories 302 may be implemented as semiconductor memories, magnetically readable memories, and/or optically readable memories, for example.

FIG. 29 illustrates that the coin acceptor 252, the bill acceptor 254, the ticket reader/printer 256, the card reader 258, the control panel 266, the display unit 270, the keypad 284, the input pad 286 (and optionally the stylus 287), the port/antenna 288, the digital camera 292, the scanner 294, the retinal scanner 296, the fingerprint scanner 297 and the microphone 298 may be operatively coupled to the I/O circuit 308, each of those components being so coupled by either a unidirectional or bidirectional, single-line or multiple-line data link, which may depend on the design of the component that is used. The speaker(s) 262 may be operatively coupled to a sound circuit 312, that may comprise a voice- and sound-synthesis circuit or that may comprise a driver circuit. The sound-generating circuit 312 may be coupled to the I/O circuit 308.

As shown in FIG. 29, the components 252, 254, 256, 258, 266, 270, 284, 286, 287, 288, 292, 294, 296, 297, 298, 312 may be connected to the I/O circuit 308 via a respective direct line or conductor. Different connection schemes could be used. For example, one or more of the components shown in FIG. 28 may be connected to the I/O circuit 308 via a common bus or other data link that is shared by a number of components. Furthermore, some of the components may be directly connected to the microprocessor 304 without passing through the I/O circuit 308.

In some embodiments, at least one of the game symbols comprises a game enhancing symbol that confers a game enhancing element to the player. It is further preferred that the game enhancing element modifies the result of a play of the game, which can be any one or combination of the base game 8, 30 and feature game 9, 40. The game enhancing elements may provide different types of effects or modifications of the game play result. In one embodiment, the game enhancing element comprises the award of one or more plays of the game that do not require a bet from the player. In other words, the game enhancing element awards a predetermined number of “free” games. In some embodiments, the game enhancing element comprises at least one or more a win multiplier, wild multipliers, bonus wilds, symbols that cause the award of additional free games, trigger symbols to retrigger the at least two second arrays, held columns, random wild symbols, stacked symbols, bonus symbols, new game symbols, reveal symbols, progressives, bonus credits, jackpot symbols, and one or more symbol replacements. A variety of game enhancing elements can be awarded by the game enhancing symbols, including:
symbols that award a predetermined number of free plays of the game;
win multiplier symbols that multiply the amount of any win from one of the predetermined winning combinations;
“wild” symbols that cause the display of substitute symbols in randomly selected symbol positions;
bonus symbols that awards a bonus prize, either as a monetary amount or as a bonus credit;
wild multiplier symbols that cause the display of substitute symbols on the array 11 and multiplies the amount of any win from one of the predetermined winning combinations;
bonus wild symbols that cause the display of substitute symbols on the array 11 and awards a bonus prize;
symbols that cause the award of additional free plays of the game;
symbols that cause one or more of the symbol positions to be held static (typically one or more reels 12a to 12e) and display substitute symbols on the array 11;
symbols that cause the same game symbol to be stacked in a group of symbol positions, typically the group being one or more reels 12a to 12e.
symbols that cause the display of new game symbols on the array 11;
“reveal” symbols that cause a game symbol to reveal another game symbol; and
“replacement” symbols that cause one or more game symbols to be replaced by other game symbols in the array 11.

These game enhancing symbols do not modify the function or value of the game symbols 10 that appear on the arrays 11, but instead confer bonus prizes, free games or change existing game symbols for other game symbols (such as replacing picture, royal card or symbols belonging to a reel with wild/substitute symbols). Where the function of game symbols 10 have been changed or the game symbols 10 are replaced, then this modification can take effect with the next play of the game instead of applying to the result of the spun array 11. In another embodiment, the game enhancing symbols may indicate the duration in which its game enhancing element is applied, such as a predetermined number of spins or a predetermined time period.

It will be appreciated that in other embodiments, game enhancing elements can also be awarded as a separate aspect of the games 8, 9, 30, 40. The game enhancing elements may further be awarded in addition or as an alternative to the enhanced prizes awarded based on winning combinations of game symbols 10 in the games 8, 9, 30, 40. In a further embodiment, the award of game enhancing elements can be done by way of another reel added to the reels of the array 11 in the games 8, 9; a sixth reel to the reels of games 30, 40 or the appearance of game enhancing symbols in the reels 12a to 12e. The additional or sixth reel in this case is simply added as an extension to the array 11 and spins either game enhancing symbols or “blank” symbols.

In some embodiments, the game enhancing symbols include “collector”-type game enhancing symbols which award points or tokens. The collection of points or tokens during the base game 8, 30 and/or feature game 9, 40 leads to the trigger of additional prizes or game enhancing symbols, depending on the number of points or tokens that are collected. These additional prizes can include stand alone progressive jackpots, bonus prizes and super games, which are enhanced versions of free spins or games where there are greater pay outs or frequency of wins.

In other preferred forms, the game enhancing element can be an enhanced version of the array 11. The enhanced array may provide additional game enhancing symbols that include the award of points or an additional number of free spins of the array 11 (for example, retriggering 5 more free spins). The collection of points awarded by the enhanced array during free spins or game leads to the trigger of additional prizes or game enhancing symbols, depending on the number of points that are collected. These additional prizes can include stand alone progressive jackpots, bonus prizes and super games, which are enhanced versions of free spins or games where there are greater pay outs or frequency of wins. In addition, the enhanced array has a different visual representation to the array 11. In addition, the enhanced array may provide game enhancing symbols of greater value and/or frequency compared to the array 11.

Where the game enhancing element comprises the award of a jackpot prize, it can take the form of a standalone progressive jackpot, fixed jackpot, mystery jackpot, symbol driven jackpot and any combination thereof (i.e. a mixture of different types of jackpots). In some embodiments, the jackpots are limited to the feature games 9, 40. In other embodiments, the jackpots are shared by all the games 8, 9, 30, 40. That is, the jackpots could be won through play of the games 8, 9, 30, 40.

A progressive jackpot prize takes a portion of each bet (typically a set percentage of each bet) made on the gaming machine and thus the amount of the progressive jackpot incrementally increases as more bets are made on the gaming machine 1. The progressive jackpot is typically awarded when a winning game combination associated with the jackpot occurs in the game played on the gaming machine. In many cases, progressive jackpots are associated with the least probable winning combination and are commonly the highest paying award of the gaming machine. In other cases, a separate trigger event can be used to award the progressive jackpot prize, such as a special jackpot symbol, a trigger event internally generated by the electronic game controller. Alternatively, or additionally, once a certain threshold is met, either a certain amount that has been bet on the gaming machine or the incremented amount of the progressive jackpot, a trigger event is activated in the electronic gaming machine to pay out the progressive jackpot prize. Progressive jackpot prizes also tend to be shared amongst multiple gaming machines so as to increase the amount of the progressive jackpot prize and hence increase player interest in playing one of the electronic gaming machines. In some gaming machines, more than one jackpot or progressive jackpot are offered by the gaming machine or gaming machines linked together.

The jackpot or bonus prizes may also be mystery jackpots rather than symbol driven jackpots. That is, none of the symbols in the game trigger the jackpot; hence the trigger event is a “mystery”. By way of comparison, a standard jackpot is typically symbol driven in that a particular combination of symbols must occur in the game to trigger the standard jackpot.

The trigger event for the mystery jackpot can be one randomly generated by the electronic game controller 4 for each play of the games 8, 9, 30, 40. One way to implement the random determination of the trigger event is for the electronic game controller 4 to internally generate a random number and check if it is a predetermined number or within a predetermined range of numbers that will initiate the appearance of the trigger symbols. For example, the predetermined range of numbers could be the range of numbers between 1 and 10 and the electronic game controller 4 internally generates a random number between 1 and 100. If the generated number is any one of numbers 1 to 10, then this results in the electronic game controller 4 causing the trigger event to occur and award the progressive jackpot prize. It will be appreciated that this manner of determining the trigger event may also be used to determine whether the feature game 9, 40 is triggered in the base game 8, 30.

Progressive jackpots can be confined to the gaming machine 1 as so called “standalone” progressive jackpots. Alternatively, the jackpot is a wide area or an in-house linked progressive jackpot prize. In other embodiments, one or more the progressive jackpot prizes are configured to be part of a wide area or in-house linked progressive jackpot prize. In other words, the progressive jackpot prizes can be awarded on a group of networked gaming machines in a specified area or a group of specified gaming machines that are linked together for jackpot purposes (usually via a central jackpot controller). The jackpot prizes can also be shared with any other games offered on the same gaming machine 1 (as in multi-game gaming machines).

During play of the games 8, 9, 30, 40, the electronic game controller 4 will determine whether the trigger event for the jackpot has occurred. In response to the occurrence of the jackpot trigger event(s), the electronic game controller 4 transmits a signal to the video screen 7 to cause the jackpot(s) associated with the jackpot trigger event(s) to be awarded to the player. After the jackpot(s) are awarded, the amounts for any awarded jackpots are reset. The amounts of the jackpots that have been won can be reset either to a predetermined start amount or simply increment upwardly from zero where the won jackpot is a progressive jackpot.

In some embodiments, the in-game trigger event is determined at the end or during the play of the game; i.e. at the end or during a spin of the reels 12. In some embodiments, the in-game trigger event occurs in a preceding play of the game so that the result of the in-game trigger event takes place in a subsequent play of the game, typically the next play of the game after the preceding play but could include a later successive play of the game.

Furthermore, the embodiments of the invention have been described as providing a rectangular array for the base game 8 and feature game 9 and a standard 5×3 array for the base game 30 and the feature game 40. However, it will be appreciated that in other embodiments, the size and shape of the base game array and feature game array may vary as desired. For example, the arrays 11 could take any number of different shapes, such as triangular, circular, square, hexagonal, hemi-spherical or other polygonal shapes. For example, the base game array 11 could comprise a circular array having three rings (equivalent to rows) like a bullseye target segmented into five columns. The feature game array would then expand into additional rings surrounding the initial rings of the base game array 11. Alternatively, the arrays 11 could have an unequal number of rows or columns. For example, the reels 12a, 12b could have three rows, but the reels 12c to 12e could have four rows.

While the preferred embodiment of the invention has been described primarily in relation to a feature game 40, those skilled in the art will appreciate that the use of symbol meters 42 for game symbols 10, the movement of the symbol meters to the win meter 45 and the variation in size of the win meter can readily be applied to the base game alone or a feature game alone.

In some embodiments, the bonus or jackpot prizes are selected after an initial random assignment of multiplier values and/or base values, where the randomly assigned multiplier and/or base values are weighted to increase as the amount of the bet made by the player to play the base game 8 increases.

In some embodiments, the frequency of particular game symbol, such as a symbol having a high value symbol meter or a substitute symbol, is controlled by choosing different reel strips to display the game symbols 10 in the games 8, 9, 30, 40. Thus, more of that type of symbol appears on the reels 12 as the bet made by the player increases. This means that the frequency of awarding a bonus prize increases, instead of the amount of the bonus or jackpot prize increasing. There may also be a combination of frequency of that type of symbol and using different reel strips with different bonus prizes. Other embodiments may use a free spins bonus where the bonus or jackpot prize values are determined by the player's initiating bet multiplier as well as which free spin is being played or by how many special symbols have been collected or accumulated in the free spins so far.

In some embodiments, the number of Mini and Major bonus prize symbols act as multipliers for the Mini and Major bonus prizes. That is, the number of Mini and Major bonus prize symbols multiplies the amount of the Mini and Major bonus prizes won by the player at the conclusion of the feature game. In other words, each Mini and Major bonus prize symbol represents its own Mini and Major bonus prize that can be won multiple times.

In a further variation to the embodiment, additional jackpots are awarded for filling a predetermined number of the game positions with the special symbol. For example, if the player is able to accumulate special symbols in thirteen game positions, then he or she would receive a Maxi progressive jackpot. If the player is able to accumulate special symbols in special game positions, then he or she would receive a Major progressive jackpot. If the player is able to accumulate special symbols in all fifteen game positions of the array, then he or she would receive a Grand progressive jackpot. Thus, more generally, a threshold number of game positions displaying the special symbol results in the award of a bonus prize of higher worth and in some embodiments that threshold number is a majority of the number of the available game positions 13 in the array 11.

Another variation to the embodiment awards a free spin for each special symbol displayed in a game position 13 in the array 11. Thus, if the player completes the array 11, he or she would receive nine free spins. Thus, more generally additional plays of the game are awarded as the number of game positions 13 displaying the special symbol increases. Where the player still has a number of free spins remaining when the array 11 is completed, and the remaining free spins are used for the following game. Alternatively, the game also ends when all fifteen game positions 13 are filled with the special symbol and the player wins the Grand progressive jackpot.

Yet another variation to the embodiment, the bonus or jackpot prize values increase as more game positions 13 displaying the special symbol appear on the array 11, thus increasing the value of the potential prizes to be won. Alternatively, the bonus or jackpot prize values increment (with each spin of a free game by the amount of the bet made by the player.

In a further variation to the embodiments, each game or symbol position 13 comprises its own individual reel and three of the reels are grouped into columns 12a to 12c or 12a to 12e of reels. That is, each symbol position 13 has its own individual reel strip of game symbols.

In other embodiments, the gaming machine 1 also offers the player the opportunity to play in community games against other players in so-called tournament games, or even in player versus player games. This is typically implemented by electronically linking several gaming machines 1 in a group within a gaming venue. The player versus player or tournament game can be played simultaneously by the players or can be staggered, with some players playing at one time and some players playing at another time in the same game. In this situation, the player versus player or tournament game comprises the award of an additional bonus prize in addition to the jackpot prizes in said selected available jackpot set.

While the same game format is essentially used across the base game 8, 30 and feature game 9, 40, it will be appreciated that the game format may vary across the base and feature games, as well as between base games where more than one game is offered by the same electronic gaming machine 1. For example, one of the games 8 may be a wheel-type game or a four reel game and another of the games may be a standard five reel game. Similarly, the games may each have different game symbols, game rules and pay tables that are unique to each game.

While one embodiment of the invention has been described in relation to a base game 8, 30 and a feature game 9, 40, it will be appreciated that the invention could include one or more additional feature games that are triggered by specific trigger symbols appearing in the feature game 9, 40. Also, the additional feature games may also have trigger symbols that trigger further feature games in a cascading fashion. These additional and further feature games could have the same game play elements as the feature game 9, 40 or be different feature games entirely.

In other embodiments, the base game 8, 30 and the feature game 9, 40 need not be displayed alternately on a single video screen 7. Instead, they may be displayed on the same video screen 7, with the base game 8, 30 shown in the lower playing area 7a and the feature game 9, 40 shown in the upper display area of the video screen 7. Alternatively, the base game 8, 30 and the feature game 9, 40 are shown on separate video screens, with the base game 8, 30 shown in a lower video screen corresponding to the lower playing area 7a and the feature game 9, 40 shown in an upper video screen corresponding to the upper display area. Also, the order can be reversed, with the lower playing area 7a or video screen showing the feature game 9, 40 and the upper video screen or upper playing area of a single video display screen 7 showing the base game 8, 30.

In another embodiment, the video screen 7 is a touch screen for use in addition to the player-actuatable buttons 6 so as to enable the player to select the bet level (such as bet denominations or bet per pay line 14) as well as other various features, such as making monetary bets for the game, initiating play of any base and feature games played and responding to any messages or requests issued on the gaming machine 1 by the electronic game controller 4. In this case, the player may control when the reels 12 start spinning and stop spinning, either individually or collectively, by simply touching the reels 12. Control over spinning of the reels 12 can also be implemented through the buttons 6 on the console 3. This increases player interaction and provide the player with an opportunity to guess when a particular game symbol 10 may appear in the reels 12.

In some embodiments, in response to a feature game trigger event in the base game, the game controller causes the display to display game symbols for playing the feature game. Alternatively, the game controller causes the display of the feature game and the base game during play of the base game, the feature game being inactive until triggered. In this embodiment, the change in the feature game from being inactive to active may be indicated on the display. This indication may be visual, aural or a combination of both.

In some embodiments, the gaming machine comprises an input device for receiving commands from the player to play the game, wherein the input device comprises one or more buttons in electronic communication with the game controller to transmit the player commands to the game controller.

In some embodiments, the input device comprises one or more buttons on the housing, the buttons being in electronic communication with the game controller. In other embodiments, the buttons are arranged on a console of the housing. Alternatively or additionally, the input device comprises a touch sensitive surface on the display for receiving commands from the player, the touch sensitive surface being in electronic communication with the electronic game controller to transmit the player commands to the game controller.

In some embodiments, the gaming machine comprises a value transfer mechanism for receiving value from the player to make a bet and initiate a play of the game. In other embodiments, the value transfer mechanism also pays the prizes to the player using value in an amount equal to an awarded prize. It is further preferred that the housing comprises the value transfer mechanism. In one embodiment, the value transfer mechanism comprises one or more vending slots for paying and/or receiving value. In other embodiments, the value transfer mechanism comprises a value input/value output device. In further embodiments, the value transfer mechanism comprises a coin slot or acceptor, a paper currency acceptor, a ticket reader and/or printer or a card reader and/or writer.

In some embodiments, the symbol meter varies in size as it moves toward the win meter. Preferably, the symbol meter initially increases in size as it moves toward the win meter. Additionally or alternatively, the symbol meter decreases in size when it is near the win meter.

In some embodiments, a symbol meter is provided for two or more game symbols shown on the array and the symbol meter for each of the game symbols forming part of the at least one winning combination moves toward the win meter to increase the amount of the win meter by the values of the symbol meters. Preferably, the symbol meters sequentially move toward the win meter.

In some embodiments, the movement of the symbol meter is shown on the display with a three-dimensional effect.

In some embodiments, the win meter varies in size when the symbol meter arrives at the win meter. Preferably, the win meter increases in size. It is further preferred that the win meter increases in size and then returns to its original size. In other embodiments, the win meter increases by the amount of the value of the symbol meter.

In some embodiments, the variation in size of the win meter is accompanied by an animation or visual effect. In other embodiments, the variation in size of the win meter is shown on the display with a three-dimensional effect.

In some embodiments, a symbol meter is provided for two or more game symbols in the game and the symbol meter for each of the game symbols forming part of the at least one winning combination moves toward the win meter to increase the amount of the win meter by the values of the symbol meters.

In some embodiments, the symbol meter is represented as a three-dimensional image on the display.

In some embodiments, the symbol meter forms part of the at least one game symbol.

In some embodiments, a symbol meter is provided for two or more game symbols shown in the array and the prize is based on the values of the symbol meters of each of the game symbols forming part of the at least one winning combination.

In some embodiments, a symbol meter is provided for two or more game symbols in the game and the prize is based on the values of the symbol meters of each of the game symbols forming part of the at least one winning combination.

In some embodiments, a symbol meter is provided for each game symbol in the game instead of just the selected game symbols shown on the array.

In some embodiments, each the game position comprises a reel separate to the other game positions.

In some embodiments, the game enhancing element comprises at least one or more of a predetermined number of free games, a win multiplier, wild multipliers, bonus wilds, symbols that cause the award of additional free games, trigger symbols to retrigger held columns, random wild symbols, stacked symbols, bonus symbols, new game symbols, reveal symbols, progressives, bonus credits, jackpot symbols, and one or more symbol replacements.

In some embodiments, the base game and the feature game each comprises an array of rows and columns of the predetermined game positions, and the base game array is different in size and/or dimensions to the feature game array. In other embodiments, the feature game array is greater in size than the base game array. In one preferred form, the base array comprises three rows and five columns and the feature game array comprises either more than three rows or more than five columns. In a further preferred form, the feature game array is an extended base game array. In yet another preferred form, the base array comprises three rows and five columns and the feature game array initially comprises three rows or three five columns. Preferably, the feature game array may expand during gameplay to add one or more rows and/or columns to the feature game array.

In some embodiments, a feature game trigger event occurs in the base game to trigger the feature game. In one embodiment, the feature game trigger event comprises a random event determined by the electronic game controller at the start of play of the feature game. In another embodiment, the feature game trigger event comprises the appearance of at least one trigger symbol in the base game array. In another alternative, the feature game trigger event comprises an in-game event during play of the base game.

In some embodiments, the array (including the base game array and/or the feature game array) take any one of a circular, triangular, oval, semi-circular, hexagonal, pentagonal, octagonal, non-rectangular or polygonal shape.

In some embodiments, the player selectively starts and/or stops play of the base game array and/or the feature game array.

In some embodiments, the gaming machine comprises a mobile electronic gaming device. In other embodiments, the mobile electronic gaming device comprises a handheld electronic device. In one preferred form, the handheld electronic device comprises a handheld electronic gaming device or a smart phone. Alternatively, the gaming machine comprises a computer. In other embodiments, the computer is connected to a communication network.

In some embodiments, the method comprises varying the size of the symbol meter as it moves toward the win meter. Preferably, the method comprises initially increasing the size of the symbol meter as it moves toward the win meter. Additionally or alternatively, the method comprises decreasing the size the symbol meter when it is near the win meter.

In some embodiments, the method comprises providing a symbol meter for two or more game symbols shown on the array and moving the symbol meter for each of the game symbols forming part of the at least one winning combination toward the win meter to increase the amount of the win meter by the values of the symbol meters. Preferably, the method comprises sequentially moving the symbol meters toward the win meter.

In some embodiments, the method comprises showing the movement of the symbol meter on the display with a three-dimensional effect.

In some embodiments, the method comprises varying the win meter in size when the symbol meter arrives at the win meter. Preferably, the method comprises increasing the size of the win meter. It is further preferred that the method comprises increasing the size of the win meter and then returning the win meter to its original size. In other embodiments, the method comprises increasing the win meter by the amount of the value of the symbol meter.

In some embodiments, the method comprises providing an animation or visual effect to accompany the variation in size of the win meter. In other embodiments, the method comprises showing the variation in size of the win meter on the display with a three-dimensional effect.

In some embodiments, the method comprises providing a symbol meter for two or more game symbols in the game and moving the symbol meter for each of the game symbols forming part of the at least one winning combination toward the win meter to increase the amount of the win meter by the values of the symbol meters.

In some embodiments, the method comprises representing the symbol meter as a three-dimensional image on the display.

In some embodiments, the method comprises forming the symbol meter as part of the at least one game symbol.

In some embodiments, the method comprises providing a symbol meter for two or more game symbols shown in the array and calculating the prize from the values of the symbol meters of each of the game symbols forming part of the at least one winning combination.

In some embodiments, the method comprises providing a symbol meter for two or more game symbols in the game and calculating the prize from the values of the symbol meters of each of the game symbols forming part of the at least one winning combination.

In some embodiments, the base game and the feature game each comprises an array of rows and columns of the predetermined game positions, and the method further comprises displaying the base game array in a different size and/or dimensions to the feature game array. In one preferred form, the method comprises providing the feature game array that is greater in size than the base game array. In another preferred form, the method comprises providing the base array with three rows and five columns and the feature game array with either more than three rows or more than five columns.

It will be appreciated that while the preferred embodiments have been described in relation to an industry standard electronic gaming machine, the invention can be readily applied to other types of electronic gaming machines, including a personal computer (standing alone or connected to a communications network, LAN or WAN), mobile electronic devices (such as handheld or portable electronic devices like tablets and smart phones) and other electronic devices capable of displaying a game. In the case of mobile electronic device, in one arrangement it may permit the player to make bets using “virtual” credits that represent a monetary value, but do not require the player to make a monetary transaction. Instead, the invention may provide a tiered access to the various features of the game so that the player can make relatively small payments to access particular features of the game or obtain additional benefits during game play. An alternative arrangement would require the player to purchase virtual credits or tokens via an interface on the mobile electronic device or an online interface accessible by the mobile electronic device. Similarly, either of the above described arrangements can be applied where the invention is implemented on a personal computer (PC) connected to the internet (wirelessly or not). In one example of the implementation, the PC would access an online casino over the Internet to play the game of the invention or the game of the invention would be part of a social networking website. It is also contemplated that the player could also make regular payments to subscribe to continue playing the game on the mobile electronic device, PC or other electronic device.

In an alternative embodiment, the gaming machine also provides an option for the player to play with either credits based on a monetary amount or virtual credits as discussed above. This can be implemented by way of a selection menu prior to playing the selected game or by providing a suitable menu button on screen during play of the selected game.

In another aspect, the invention includes a computer program configured to perform the invention. In this way the invention can be implemented in various ways on a gaming machine. In a further aspect, the invention includes a gaming system configured comprising a central processing unit (such as a computer or computational processor) configured for communication with a gaming machine to perform the invention. In a yet another aspect, the invention includes a non-transitory computer readable or carrier medium carrying computer executable code that, when executed on a central processing unit configured for communication with a gaming machine, causes the central processing unit to perform the invention. In this case, the non-transitory carrier medium includes an external hard drive, a memory device, including a memory card, smart card, a radio frequency identification (RFID) device, USB key, magnetic card or other electronic storage device.

While the illustrated embodiments include an electronic display on which the array of game positions is displayed, it will be recognized that the disclosed embodiments could instead incorporate mechanical or electro-mechanical reels to define the array of game positions. In fact, to the extent that the game positions, game symbols or operation of the gaming machine described herein would require a modification of such mechanical or electro-mechanical reels, it will be recognized that the embodiment represents a change in the structure or operation of a machine, rather than simply a variation in the rules of playing a game. In addition or in the alternative, the variation in the game positions, game symbols or operation of the gaming machine described herein may be viewed as analogous to a method for utilizing a new game apparatus (like a new deck of cards), rather than simply as a new set of rules in and of themselves.

It will further be appreciated that any of the features in the preferred embodiments of the invention can be combined together and are not necessarily applied in isolation from each other. For example, the feature of the player being able to selectively starting or stopping spinning of the reels 12 and the feature of providing separate video screens for the lower playing area 7a and upper display area 7b can be combined into a single gaming machine 1. Similar combinations of two or more features from the above described embodiments or embodiments of the invention can be readily made by one skilled in the art.

By providing symbol meters for game symbols, movement of the symbol meters to the win meter and variation in size of the win meter, the award of prizes for winning combinations is provided efficiently and in a more entertaining manner to the player and so enhances both the operation of the gaming machine and how the game controller is used to playing the games on the gaming machine. This improved operation of the gaming machine and application of the game controller increases the player's interest as he or she can determine from the display which game symbols have more value due to their associated symbol meters, as well as being able to see the win meter increase as each symbol meter moves toward the win meter and the win meter expands in size. Moreover, the symbol meter enables game designers to control the volatility of the gaming machine without having the change other aspects of the game that may attracts players. The invention also adds greater value to a player in terms of the probability of winning a prize and providing greater variety in game play, especially compared to a conventional gaming machine that only has one set of reels and a single feature game. All these advantages of the invention result in the player being more likely to retain interest in continuing to play the same gaming machine due to the variation in game play on the gaming machine. Furthermore, since the game controller controls operation of the gaming machine, the invention can be readily implemented to existing gaming machines, including EGMs, electro-mechanical or purely mechanical gaming machines as well as other gaming systems. In all these respects, the invention represents a practical and commercially significant improvement over the prior art.

Although the invention has been described with reference to specific examples, it will be appreciated by those skilled in the art that the invention may be embodied in many other forms.

1. A gaming machine comprising:
a display for displaying a game, wherein said game comprises randomly selected game symbols displayed in an array of game positions and where predetermined winning combinations of said randomly selected game symbols in said game award prizes to a player;
a game controller for controlling the display of said game symbols on said display; and
a value transfer mechanism for receiving value from said player, wherein said game controller communicates with said value transfer mechanism such that when a threshold amount of value has been received from said value transfer mechanism, said game controller initiates a play of said game;
wherein game controller said provides a symbol meter for at least one game symbol shown in said array, wherein said symbol meter has a value;
in response to at least one winning combination appearing on said array comprising said at least one game symbol, said game controller awards a prize for said at least one winning combination based in part on the value of said symbol meter of said at least one game symbol; and
said symbol meter moves toward a win meter to increase the amount of said win meter by the value of said symbol meter.

2. The gaming machine of claim 1, wherein said symbol meter varies in size as it moves toward said win meter.

3. The gaming machine of claim 2, wherein said symbol meter initially increases in size as it moves toward said win meter.

4. The gaming machine of claim 3, wherein said symbol meter decreases in size when it is near said win meter.

5. The gaming machine of claim 2, said symbol meter decreases in size when it is near said win meter.

6. The gaming machine of claim 2, wherein a symbol meter is provided for two or more game symbols shown on said array and said symbol meter for each of said game symbols forming part of said at least one winning combination moves toward said win meter to increase the amount of said win meter by the values of said symbol meters.

7. The gaming machine of claim 6, wherein said symbol meters sequentially move toward said win meter.

8. The gaming machine of claim 2, wherein said movement of said symbol meter is shown on said display with a three-dimensional effect.

9. The gaming machine of claim 1, wherein said win meter varies in size when said symbol meter arrives at said win meter.

10. The gaming machine of claim 9, wherein said win meter increases in size.

11. The gaming machine of claim 9, wherein said win meter increases by the amount of said value of said symbol meter.

12. The gaming machine of claim 9, wherein said win meter increases in size and then returns to its original size.

13. The gaming machine of claim 9, wherein said variation in size of said win meter is accompanied by an animation or visual effect.

14. The gaming machine of claim 9, wherein said variation in size of said win meter is shown on said display with a three-dimensional effect.

15. The gaming machine of claim 1, wherein a symbol meter is provided for two or more game symbols in said game and said symbol meter for each of said game symbols forming part of said at least one winning combination moves toward said win meter to increase the amount of said win meter by the values of said symbol meters.

16. The gaming machine of claim 1, wherein said symbol meter is represented as a three-dimensional image on said display.

17. The gaming machine of claim 1, wherein said symbol meter forms part of said at least one game symbol.

18. A gaming machine comprising:
a display for displaying a game, wherein said game comprises randomly selected game symbols displayed in an array of game positions and where predetermined winning combinations of said randomly selected game symbols in said game award prizes to a player;
a game controller for controlling the display of said game symbols on said display; and
a value transfer mechanism for receiving value from said player, wherein said game controller communicates with said value transfer mechanism such that when a threshold amount of value has been received from said value transfer mechanism, said game controller initiates a play of said game;
wherein said game controller provides a symbol meter for at least one game symbol shown in said array, wherein said symbol meter has a value; and
in response to at least one winning combination appearing on said array comprising said at least one game symbol, said game controller awards a prize for said at least one winning combination based in part on the value of said symbol meter.

19. The gaming machine of claim 18, wherein a symbol meter is provided for two or more game symbols shown in said array and said prize is based on the values of said symbol meters of each of said game symbols forming part of said at least one winning combination.

20. The gaming machine of claim 18, wherein a symbol meter is provided for two or more game symbols in said game and said prize is based on the values of said symbol meters of each of said game symbols forming part of said at least one winning combination.

21. The gaming machine of claim 18, wherein said symbol meter is represented as a three-dimensional image on said display.

22. The gaming machine of claim 18, wherein said value of said symbol meter varies during play of said game.
